(19) United States
(12) Patent Application Publication
(10) Pub. No.: US 2024/0072900 A1
(43) Pub. Date: Feb. 29, 2024

(54) OPTICAL AMPLIFIER, COMMUNICATION MODULE, AND OPTICAL TRANSMISSION APPARATUS

(71) Applicant: FUJITSU OPTICAL COMPONENTS LIMITED, Kawasaki-shi (JP)

(72) Inventor: Daisuke MATSUKAWA, Kawasaki (JP)

(73) Assignee: FUJITSU OPTICAL COMPONENTS LIMITED, Kawasaki-shi (JP)

(21) Appl. No.: 18/216,972

(22) Filed: Jun. 30, 2023

(30) Foreign Application Priority Data
Aug. 30, 2022 (JP) 2022-136987

(51) Int. Cl. H04B 10/291; H04B 10/079

(52) U.S. Cl. CPC H04B 10/2912; H04B 10/07955; H04B 2210/003

(57) ABSTRACT

An optical amplifier includes a first path and a second path, and an amplification unit that is arranged on one of the first path and the second path. The amplifier includes a first switch that is arranged on an input stage of the amplification unit, and that switches a third path that connects between the first path and the amplification unit or a fourth path that connects between the second path and the amplification unit. The amplifier includes a second switch that is arranged on an output stage of the amplification unit and that switches a fifth path that connects between the first path and the amplification unit or a sixth path that connects between the second path and the amplification unit. The first switch switches the third path over to the fourth path, and the second switch switches the fifth path to the sixth path.

### CROSS-REFERENCE TO RELATED APPLICATION

This application is based upon and claims the benefit of priority of the prior Japanese Patent Application No. 2022-136987, filed on Aug. 30, 2022, the entire contents of which are incorporated herein by reference.

### FIELD

The embodiments discussed herein are related to an optical amplifier, a communication module, and an optical transmission apparatus.

### BACKGROUND

In recent years, a communication device with a small size built-in communication module suitable for, for example, optical transmission over a long distance is widely used. FIG. 14 is a diagram illustrating one example of a configuration of a communication module that is conventionally used. A communication module 100 illustrated in FIG. 14 is optically connected to an optical transmission path 101A that is disposed on a transmission side, and is also optically connected to an optical transmission path 101B that is disposed on a reception side.

The communication module 100 includes a digital signal processor (DSP) 111, an optical transmission unit 112, an optical reception unit 113, an optical amplification unit 114, an isolator 115, an optical switch 116, and a control unit 117. The DSP 111 is a processor that generates transmission data and that executes signal processing to acquire reception data. The optical transmission unit 112 that performs optical conversion on the transmission data received from the DSP 111 and generates transmission light. The optical reception unit 113 performs electric conversion on the received reception light and then acquires reception data. The optical amplification unit 114 optically amplifies the transmission light received from the optical transmission unit 112. The isolator 115 allows transmission of signal light travelling in a forward direction (transmission direction) to pass, and blocks signal light received from an inverse direction (reception direction).

The optical switch 116 is a switch that switches a path that connects between the isolator 115 and the optical transmission path 101A that is disposed on the transmission side, a path that connects between the optical reception unit 113 and the optical transmission path 101B that is disposed on the reception side, and a path that connects between the optical reception unit 113 and the optical transmission path 101A that is disposed on the transmission side. Furthermore, the control unit 117 performs switching control of the paths in the optical switch 116.

In addition, the DSP 111 has an optical time domain reflectometer (OTDR) function for measuring a distance to a communication device provided on the destination side or to a fault location on the optical transmission path 101A disposed on the transmission side. The OTDR function transmits pulse light to the optical transmission path 101A that is disposed on the transmission side by using the optical transmission unit 112, and receives reflected light with respect to the pulse light from the optical transmission path 101A disposed on the transmission side by using the optical reception unit 113. Consequently, the OTDR function measures, by using the reflected light received by the optical reception unit 113, the distance to a communication device that is provided on the destination side and that is located on the optical transmission path 101A that is disposed on the transmission side and the distance to a fault location on the optical transmission path 101A that is disposed on the transmission side.

The control unit 117 included in the communication module 100 controls, at the time of transmission, the optical switch 116 in order to switch over to the path that connects between the isolator 115 and the optical transmission path 101A that is disposed on the transmission side. Then, the optical transmission unit 112 performs optical conversion on the transmission data received from the DSP 111 to convert the transmission data to transmission light, and transmits the obtained transmission light to the optical amplification unit 114. Furthermore, the optical amplification unit 114 optically amplifies the transmission light, and transmits the transmission light that has been optically amplified to the optical transmission path 101A that is disposed on the transmission side via the isolator 115 and the optical switch 116.

The control unit 117 included in the communication module 100 controls, at the time of reception, the optical switch 116 in order to switch over to the path that connects between the optical transmission path 101B that is disposed on the reception side and the optical reception unit 113. Then, the optical reception unit 113 receives the reception light from the optical transmission path 101B disposed on the reception side via the optical switch 116, and transmits the reception data obtained by performing electric conversion on the received reception light to the DSP 111.

The control unit 117 included in the communication module 100 controls, at the time of an OTDR measurement, the optical switch 116 in order to switch over to the path that connects between the isolator 115 and the optical transmission path 101A that is disposed on the transmission side. Then, the optical transmission unit 112 transmits the pulse light to the optical transmission path 101A disposed on the transmission side by way of the path route of the optical amplification unit 114→the isolator 115→the optical switch 116. Furthermore, after the pulse light has been transmitted to the optical transmission path 101A that is disposed on the transmission side, the control unit 117 controls the optical switch 116 in order to switch over to the path that connects between the optical transmission path 101A disposed on the transmission side and the optical reception unit 113. Then, the optical reception unit 113 receives the reflected light with respect to the pulse light from the optical transmission path 101A disposed on the transmission side by way of the optical switch 116. Then, the OTDR function included in the DSP 111 measures a distance to the destination point on the basis of the reception result of the reflected light received from the optical reception unit 113.

However, with the communication module 100 that is conventionally used, if each of the optical transmission path 101A disposed on the transmission side and the optical transmission path 101B disposed on the reception side is a long distance path, power of the reflected light received from the optical transmission path 101A disposed on the transmission side and power of the reception light received from the optical transmission path 101B disposed on the reception side are largely attenuated. Accordingly, it is conceivable to use a communication module in which a new optical amplification unit that is used for reception is arranged in a stage preceding the optical reception unit 113.
Patent Document 1: Japanese Laid-open Patent Publication No. 2017-194306
Patent Document 2: Japanese Laid-open Patent Publication No. 07-128185

However, with the communication module described above, in addition to the optical amplification unit 114 that is disposed in a stage following the optical transmission unit 112, if the new optical amplification unit that is used for reception is arranged in the stage preceding the optical reception unit 113, the size of the communication module is increased as a result of the additional installation of the optical amplification unit.

### SUMMARY

According to an aspect of an embodiment, an optical amplifier includes a first path through which first signal light passes, a second path through which second signal light passes, an optical amplification unit, a first optical switch and a second optical switch. The optical amplification unit is arranged on one of the first path and the second path and optically amplifies the first signal light or the second signal light. The first optical switch is arranged on an input stage of the optical amplification unit and switches a path that connects between the first path and the optical amplification unit or a path that connects between the second path and the optical amplification unit. The second optical switch is arranged on an output stage of the optical amplification unit and switches a path that connects between the first path and the optical amplification unit or a path that connects between the second path and the optical amplification unit. The path that connects between the first path and the optical amplification unit is switched to the path that connects between the second path and the optical amplification unit by the first optical switch. The path that connects between the first path and the optical amplification unit is switched to the path that connects between the second path and the optical amplification unit by the second optical switch.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of a configuration of an optical amplifier according to a first embodiment;

FIG. 2 is a diagram illustrating one example of the flow of reception light (transmission light) that is in an unamplified state in the optical amplifier according to the first embodiment;

FIG. 3 is a flowchart illustrating one example of a processing operation related to a first amplification switching process performed by a control unit;

FIG. 4 is a diagram illustrating one example of a configuration of an optical amplifier according to a second embodiment;

FIG. 5 is a diagram illustrating one example of the flow of transmission light (reception light) that is in an unamplified state in the optical amplifier according to the second embodiment;

FIG. 6 is a flowchart illustrating one example of a processing operation related to a second amplification switching process performed by a control unit;

FIG. 7 is a diagram illustrating one example of a configuration of a communication module according to a third embodiment;

FIG. 8 is a flowchart illustrating one example of a processing operation related to a first OTDR measurement process performed by a control unit;

FIG. 9 is a diagram illustrating one example of a configuration of a communication module according to a fourth embodiment;

FIG. 10 is a diagram illustrating one example of a configuration of a communication module according to a fifth embodiment;

FIG. 11 is a diagram illustrating one example of a configuration of a communication module according to a sixth embodiment;

FIG. 12 is a flowchart illustrating one example of a processing operation related to a second OTDR measurement process performed by a control unit;

FIG. 13 is a diagram illustrating one example of a configuration of a communication module according to a seventh embodiment; and

FIG. 14 is a diagram illustrating one example of a configuration of a communication module that is conventionally used.

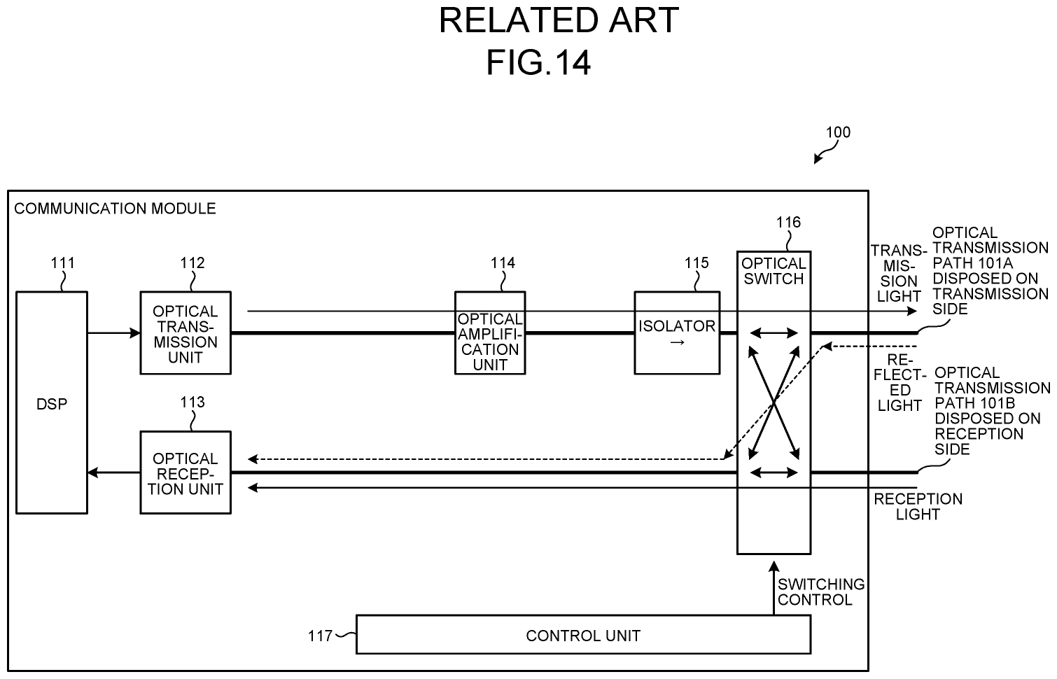

### DESCRIPTION OF EMBODIMENTS

Preferred embodiments of the present invention will be explained with reference to accompanying drawings. Furthermore, the present invention is not limited to the embodiments. In addition, each of the embodiments can be used in any appropriate combination as long as they do not conflict with each other.

### (a) First Embodiment

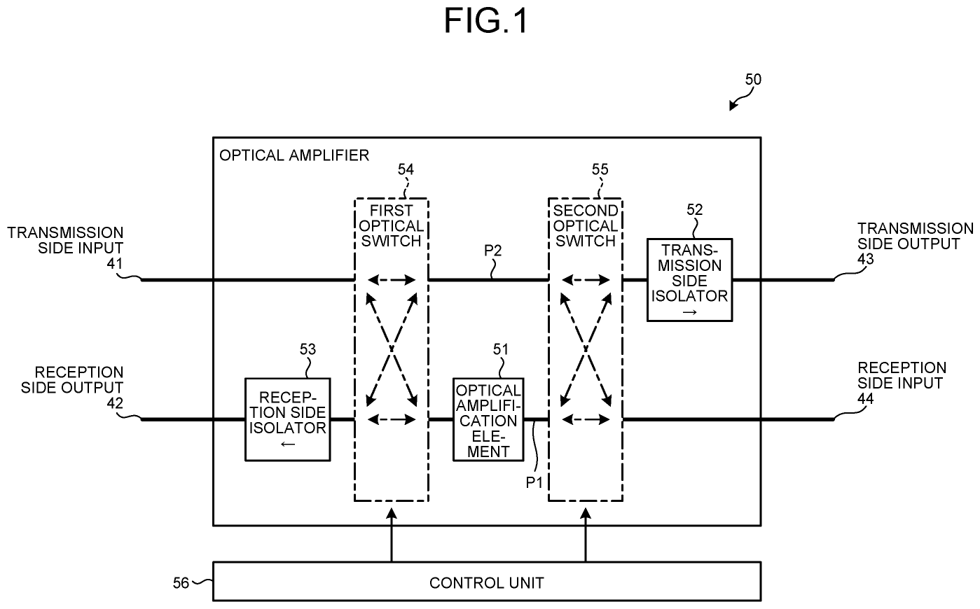

FIG. 1 is a diagram illustrating one example of a configuration of an optical amplifier 50 according to a first embodiment. The optical amplifier 50 illustrated in FIG. 1 is optically connected to a transmission side input 41, is optically connected to a reception side output 42, is optically connected to a transmission side output 43, and is optically connected to a reception side input 44. The transmission side input 41 is a first input unit that inputs transmission light that is, for example, first signal light. The reception side output 42 is a second output unit that outputs reception light that is, for example, second signal light. The transmission side output 43 is a first output unit that outputs, for example, the first signal light. The reception side input 44 is a second input unit that inputs, for example, the second signal light.

The optical amplifier 50 includes an optical amplification element 51, a transmission side isolator 52, a reception side isolator 53, a first optical switch 54, a second optical switch 55, and a control unit 56. The optical amplification element 51 is arranged on a reception path between the reception side input 44 and the reception side output 42, and optically amplifies the passing signal light. The transmission side isolator 52 is an isolator that allows transmission of signal light travelling in the forward direction that is from the transmission side input 41 toward the transmission side output 43, and that blocks the signal light travelling in the inverse direction from the transmission side output 43 toward the transmission side input 41. The reception side isolator 53 is an isolator that allows transmission of the signal light travelling in the forward direction that is from the reception side input 44 toward the reception side output 42, and that blocks the signal light travelling in the inverse direction from the reception side output 42 toward the reception side input 44. In addition, for convenience of description, the reception path that is located between the reception side input 44 and the reception side output 42 and on which the optical amplification element 51 is arranged is denoted by P1, whereas a transmission path that is located between the transmission side input 41 and the transmission side output 43 and on which the optical amplification element 51 is not arranged is denoted by P2.

The first optical switch 54 is an optical switch that switches each of the paths. These paths include a path that connects between the transmission side input 41 and the second optical switch 55, and a path that connects between the transmission side input 41 and the optical amplification element 51. Furthermore, these paths include a path that connects between the optical amplification element 51 and the reception side isolator 53, and a path that connects between the second optical switch 55 and the reception side isolator 53.

The second optical switch 55 is an optical switch that switches each of the paths. These paths include a path that connects between the optical amplification element 51 and the transmission side isolator 52, and a path that connects between the reception side input 44 and the optical amplification element 51. These paths include a path that connects between the reception side input 44 and the first optical switch 54, and a path that connects between the first optical switch 54 and the transmission side isolator 52. In addition, the mounting area of the optical amplification element is larger than the mounting area of the two optical switches 54 and 55.

The control unit 56 performs switching control on the first optical switch 54 and the second optical switch 55. The control unit 56 determines whether or not the optical amplification element 51 is needed in accordance with a transmission distance of the optical transmission path that is connected to the transmission side output 43 or a transmission distance of the optical transmission path that is connected to the reception side input 44 at the time of, for example, activation of a power supply, and then controls the first optical switch 54 and the second optical switch 55 on the basis of the determination result. If the transmission distance of the optical transmission path connected to the transmission side output 43 is a long distance, the control unit 56 determines that the optical amplification element 51 is needed, whereas, if the transmission distance of the optical transmission path is a short distance, the control unit 56 determines that the optical amplification element 51 is not needed. If the transmission distance of the optical transmission path connected to the reception side input 44 is a long distance, the control unit 56 determines that the optical amplification element 51 is needed, whereas, if the transmission distance of the optical transmission path is a short distance, the control unit 56 determines that the optical amplification element 51 is not needed.

First, an operation of the optical amplifier 50 performed when the signal light that has been input from the transmission side input 41 is optically amplified and is output to the transmission side output 43 will be described. The control unit 56 determines that the optical amplification element 51 is needed in the case where, for example, the transmission distance is a long distance. Then, the control unit 56 controls the first optical switch 54 in order to switch over to the path between the transmission side input 41 and the optical amplification element 51, and also controls the second optical switch 55 in order to switch over to the path between the optical amplification element 51 and the transmission side isolator 52.

Then, the first optical switch 54 inputs the signal light received from the transmission side input 41 to the optical amplification element 51. The optical amplification element 51 optically amplifies the signal light received from the first optical switch 54, and then inputs the signal light that has been optically amplified to the second optical switch 55. Furthermore, the second optical switch 55 outputs the signal light that has been optically amplified performed by and received from the optical amplification element 51 to the transmission side output 43 by way of the transmission side isolator 52.

An operation of the optical amplifier 50 performed when the signal light that has been input from the reception side input 44 is optically amplified and is output to the reception side output 42 will be described. The control unit 56 determines that the optical amplification element 51 is needed in the case where, for example, the transmission distance is a long distance. Then, the control unit 56 controls the first optical switch 54 in order to switch over to the path between the reception side isolator 53 and the optical amplification element 51, and controls the second optical switch 55 in order to switch over to the path between the optical amplification element 51 and the reception side input 44.

Then, the second optical switch 55 inputs the signal light received from the reception side input 44 to the optical amplification element 51. The optical amplification element 51 optically amplifies the signal light received from the second optical switch 55, and then inputs the signal light that has been optically amplified to the first optical switch 54. Furthermore, the first optical switch 54 outputs the signal light that has been optically amplified performed by and received from the optical amplification element 51 to the reception side output 42 by way of the reception side isolator 53.

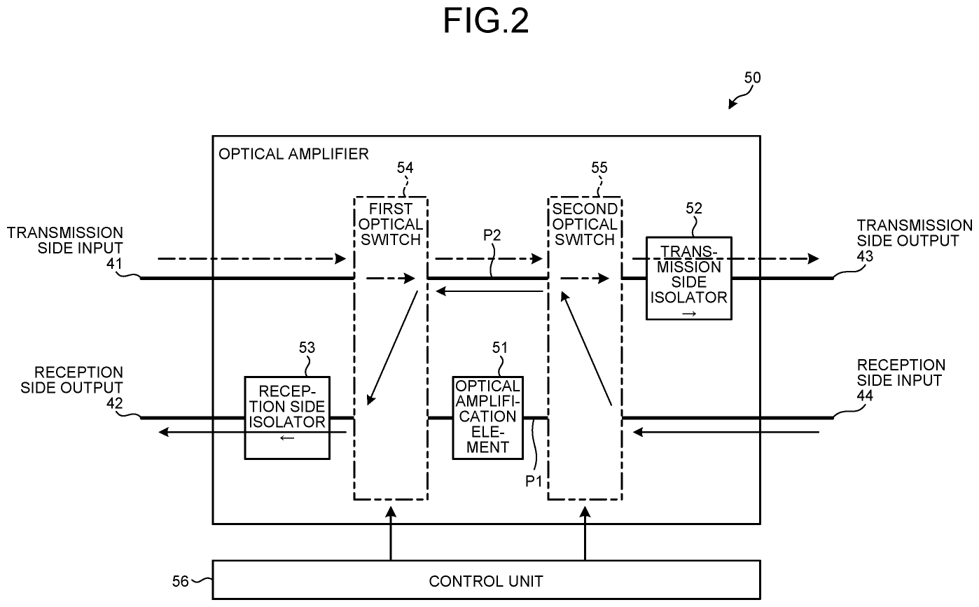

An operation of the optical amplifier 50 performed when the signal light that has been input from the transmission side input 41 is transmitted without being amplified and is output to the transmission side output 43 will be described. FIG. 2 is a diagram illustrating one example of the flow of the reception light (transmission light) that is in an unamplified state in the optical amplifier 50 according to the first embodiment. The control unit 56 determines that the optical amplification element 51 is not needed in the case where, for example, the transmission distance is a short distance. Then, the control unit 56 controls the first optical switch 54 in order to switch over to the path between the transmission side input 41 and the second optical switch 55. The control unit 56 controls the second optical switch 55 in order to switch over to the path between the first optical switch 54 and the transmission side isolator 52. Then, the first optical switch 54 outputs the signal light received from the transmission side input 41 to the second optical switch 55. The second optical switch 55 outputs the signal light received from the first optical switch 54 to the transmission side output 43 by way of the transmission side isolator 52. Consequently, the optical amplification element 51 is not used, so that it is possible to reduce the electrical power consumption at the time at which the transmission light is transmitted.

An operation of the optical amplifier 50 performed when the signal light that has been input from the reception side input 44 is transmitted without being amplified and is output to the reception side output 42 will be described. The control unit 56 determines that the optical amplification element 51 is not needed in the case where, for example, the transmission distance is a short distance. Then, the control unit 56 controls the first optical switch 54 in order to switch over to the path between the reception side isolator 53 and the second optical switch 55, and also controls the second optical switch 55 in order to switch over to the path between the reception side input 44 and the first optical switch 54. Then, the second optical switch 55 outputs the signal light received from the reception side input 44 to the first optical switch 54. The first optical switch 54 outputs the signal light received from the second optical switch 55 to the reception side output 42 by way of the reception side isolator 53. Consequently, the optical amplification element 51 is not used, so that it is possible to reduce electrical power consumption at the time at which the reception light is received.

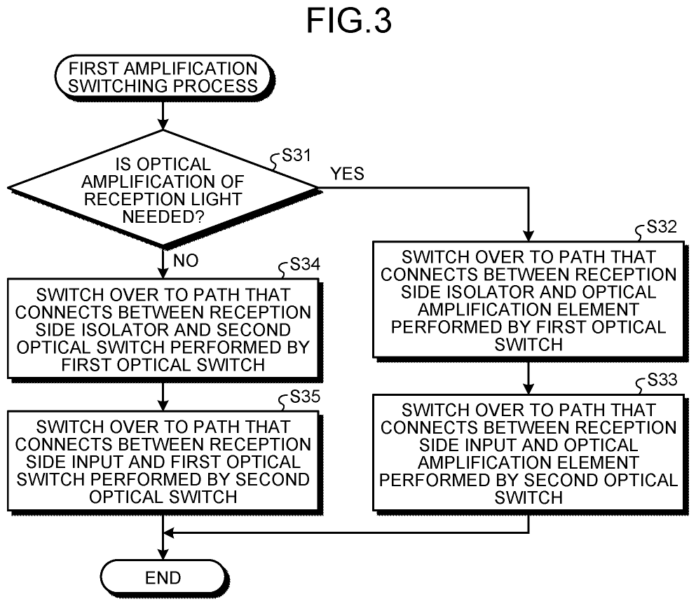

FIG. 3 is a flowchart illustrating one example of a processing operation related to a first amplification switching process performed by the control unit 56. In addition, for convenience of description, the first amplification switching process is described about the reception light that is the signal light travelling from the reception side input 44 toward the reception side output 42.

In FIG. 3, the control unit 56 determines whether or not optical amplification is needed for the reception light (Step S31). If the optical amplification is needed for the reception light (Yes at Step S31), the control unit 56 controls the first optical switch 54 in order to switch over to the path between the reception side isolator 53 and the optical amplification element 51 (Step S32). Furthermore, the control unit 56 controls the second optical switch 55 in order to switch over to the path between the reception side input 44 and the optical amplification element 51 (Step S33), and ends the processing operation illustrated in FIG. 3.

In addition, if the optical amplification is not needed for the reception light (No at Step S31), the control unit 56 controls the first optical switch 54 in order to switch over to the path between the reception side isolator 53 and the second optical switch 55 (Step S34). Furthermore, the control unit 56 controls the second optical switch 55 in order to switch over to the path between the reception side input 44 and the first optical switch 54 (Step S35), and ends the processing operation illustrated in FIG. 3.

In the first amplification switching process, if the optical amplification is needed for the reception light, the reception light is optically amplified by way of the path route of the reception side input 44→the second optical switch 55→the optical amplification element 51→the reception side isolator 53→the reception side output 42. Consequently, it is possible to acquire stable reception light even when the reception light is attenuated due to long distance transmission.

In the first amplification switching process, if the optical amplification is not needed for the reception light, it is possible to acquire the reception light by way of the path route of the reception side input 44→the second optical switch 55→the first optical switch 54→the reception side isolator 53→the reception side output 42. Consequently, for example, optical amplification is not needed in the case of short distance transmission, so that it is possible to reduce the electrical power consumption needed for the optical amplification.

In the optical amplifier 50 according to the first embodiment, it is possible to optically amplify the reception light and the transmission light by using the single unit of the optical amplification element 51 that is disposed on the reception path, so that there is no need to prepare a new optical amplification element, and it is thus possible to greatly contribute to a reduction in the size of a communication module having the optical amplifier 50 as a built-in unit.

The optical amplifier 50 controls the second optical switch 55 such that the path between the optical amplification element 51 and the reception side input 44 is switched to the path between the optical amplification element 51 and the transmission side isolator 52. The optical amplifier 50 controls the first optical switch 54 such that the path between the reception side output 42 and the optical amplification element 51 is switched to the path between the optical amplification element 51 and the transmission side input 41. Consequently, it is possible to share the single unit of the optical amplification element 51 located on the reception path in order to optically amplify the transmission light and the reception light.

In addition, for convenience of description, an example in which the optical amplification element 51 included in the optical amplifier 50 is arranged on the reception path has been described; however, the optical amplification element 51 may be arranged on the transmission path, and an embodiment thereof will be described as a second embodiment below.

### (b) Second Embodiment

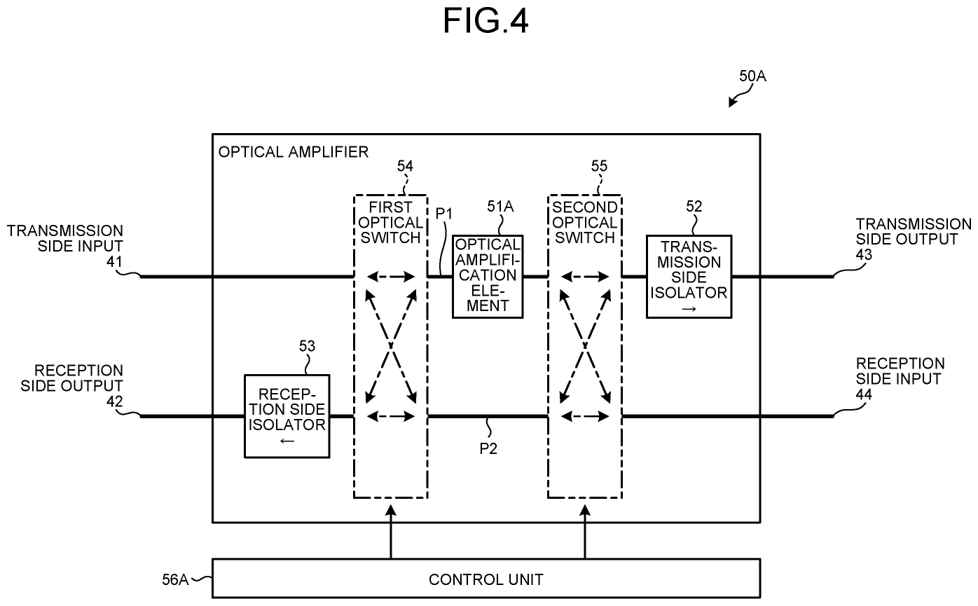

FIG. 4 is a diagram illustrating one example of a configuration of an optical amplifier 50A according to the second embodiment. In addition, by assigning the same reference numerals to components having the same configuration as those in the optical amplifier 50 according to the first embodiment, overlapped descriptions of the configuration and the operation thereof will be omitted. The optical amplifier 50A illustrated in FIG. 4 is different from the optical amplifier 50 according to the first embodiment in that the optical amplifier 50A includes an optical amplification element 51A that is arranged on the transmission path, instead of the optical amplification element 51 that is arranged on the reception path. In addition, for convenience of description, a transmission path that is located between the transmission side input 41 and the transmission side output 43 and on which the optical amplification element 51A is arranged is denoted by P1, whereas a reception path that is located between the reception side input 44 and the reception side output 42 and on which the optical amplification element 51A is not arranged is denoted by P2.

The first optical switch 54 is an optical switch that switches each of the paths. These paths include a path that connects between the transmission side input 41 and the optical amplification element 51A, and a path that connects the transmission side input 41 and the second optical switch 55. These paths include a path that connects between the optical amplification element 51A and the reception side isolator 53, and a path that connects between the second optical switch 55 and the reception side isolator 53.

The second optical switch 55 is an optical switch that switches each of the paths. These paths include a path that connects between the optical amplification element 51A and the transmission side isolator 52, and a path that connects between the reception side input 44 and the optical amplification element 51A. These paths include a path that connects between the reception side input 44 and the first optical switch 54, and a path that connects between the first optical switch 54 and the transmission side isolator 52.

A control unit 56A performs switching control of the first optical switch 54 and the second optical switch 55. The control unit 56A determines whether or not the optical amplification element 51A is needed in accordance with a transmission distance, and controls the first optical switch 54 and the second optical switch 55 on the basis of the determination result. If the transmission distance of the optical transmission path connected to the transmission side output 43 is a long distance, the control unit 56A determines that the optical amplification element 51A is needed, whereas, if the transmission distance of the optical transmission path is a short distance, the control unit 56A determines that the optical amplification element 51A is not needed. If the transmission distance of the optical transmission path connected to the reception side input 44 is a long distance, the control unit 56A determines that the optical amplification element 51A is needed, whereas, if the transmission distance of the optical transmission path is a short distance, the control unit 56A determines that the optical amplification element 51A is not needed.

First, an operation of the optical amplifier 50A performed when the signal light that has been input from the transmission side input 41 is optically amplified and is output to the transmission side output 43 will be described. The control unit 56A determines that the optical amplification element 51A is needed in the case where, for example, the transmission distance is a long distance. Then, the control unit 56A controls the first optical switch 54 in order to switch over to the path between the transmission side input 41 and the optical amplification element 51A, and also controls the second optical switch 55 in order to switch over to the path between the optical amplification element 51A and the transmission side isolator 52.

Then, the first optical switch 54 inputs the signal light received from the transmission side input 41 to the optical amplification element 51A. The optical amplification element 51A optically amplifies the signal light received from the first optical switch 54, and then inputs the signal light that has been optically amplified to the second optical switch 55. Furthermore, the second optical switch 55 outputs the signal light that has been optically amplified performed by and received from the optical amplification element 51A to the transmission side output 43 by way of the transmission side isolator 52.

An operation of the optical amplifier 50A performed when the signal light that has been input from the reception side input 44 is optically amplified and is output to the reception side output 42 will be described. The control unit 56A determines that the optical amplification element 51A is needed in the case where, for example, the transmission distance is a long distance. Then, the control unit 56A controls the first optical switch 54 in order to switch over to the path between the reception side isolator 53 and the optical amplification element 51A, and controls the second optical switch 55 in order to switch over to the path between the optical amplification element 51A and the reception side input 44.

Then, the second optical switch 55 inputs the signal light received from the reception side input 44 to the optical amplification element 51A. The optical amplification element 51A optically amplifies the signal light received from the second optical switch 55, and then inputs the signal light that has been optically amplified to the first optical switch 54. Furthermore, the first optical switch 54 outputs the signal light that has been optically amplified performed by and received from the optical amplification element 51A to the reception side output 42 by way of the reception side isolator 53.

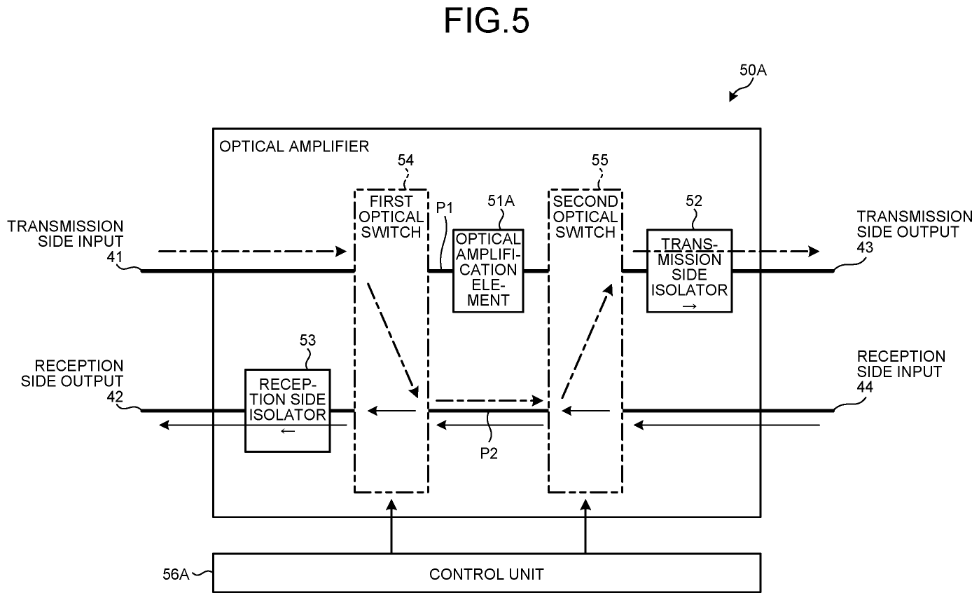

An operation of the optical amplifier 50A performed when the signal light that has been input from the transmission side input 41 is transmitted without being amplified and is output to the transmission side output 43 will be described. FIG. 5 is a diagram illustrating one example of the flow of the transmission light (reception light) that is in an unamplified state in the optical amplifier 50A according to the second embodiment. The control unit 56A determines that the optical amplification element 51A is not needed in the case where, for example, the transmission distance on the transmission side is a short distance. Then, the control unit 56A controls the first optical switch 54 in order to switch over to the path between the transmission side input 41 and the second optical switch 55, and also controls the second optical switch 55 in order to switch over to the path between the first optical switch 54 and the transmission side isolator 52. Then, the first optical switch 54 outputs the signal light received from the transmission side input 41 to the second optical switch 55. The second optical switch 55 outputs the signal light received from the first optical switch 54 to the transmission side output 43 by way of the transmission side isolator 52. Consequently, the optical amplification element 51A is not used, so that it is possible to reduce the electrical power consumption at the time at which the transmission light is transmitted.

An operation of the optical amplifier 50A performed when the signal light that has been input from the reception side input 44 is transmitted without being amplified and is output to the reception side output 42 will be described. The control unit 56A determines that the optical amplification element 51A is not needed in the case where, for example, the transmission distance on the reception side is a short distance. Then, the control unit 56A controls the first optical switch 54 in order to switch over to the path between the reception side isolator 53 and the second optical switch 55, and also controls the second optical switch 55 in order to switch over to the path between the reception side input 44 and the first optical switch 54. Then, the second optical switch 55 outputs the signal light received from the reception side input 44 to the first optical switch 54. The first optical switch 54 outputs the signal light received from the second optical switch 55 to the reception side output 42 by way of the reception side isolator 53. Consequently, the optical amplification element 51A is not used, so that it is possible to reduce electrical power consumption at the time at which the reception light is received.

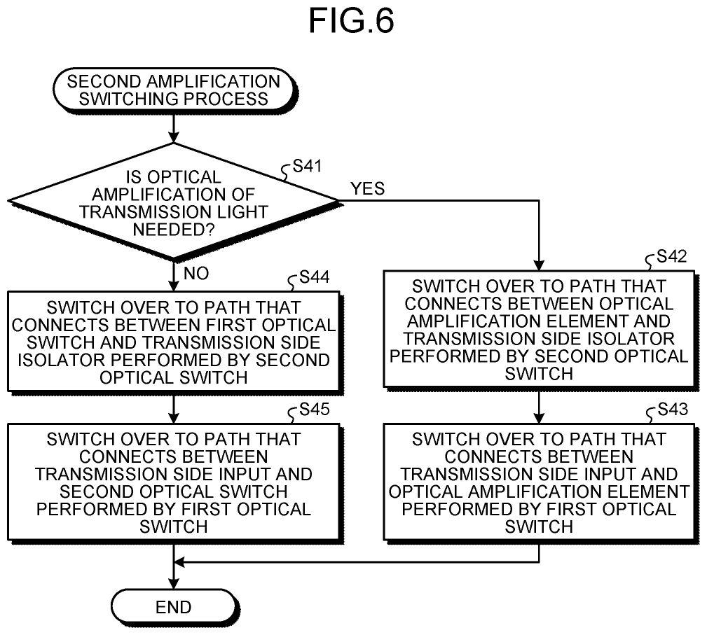

FIG. 6 is a flowchart illustrating one example of a processing operation related to a second amplification switching process performed by the control unit 56A. In addition, for convenience of description, the second amplification switching process is described about the transmission light that is the signal light travelling from the transmission side input 41 toward the transmission side output 43.

In FIG. 6, the control unit 56A determines whether or not optical amplification is needed for the transmission light (Step S41). If the optical amplification is needed for the transmission light (Yes at Step S41), the control unit 56A controls the second optical switch 55 in order to switch over to the path between the transmission side isolator 52 and the optical amplification element 51A (Step S42). Furthermore, the control unit 56A controls the first optical switch 54 in order to switch over to the path between the transmission side input 41 and the optical amplification element 51A (Step S43), and ends the processing operation illustrated in FIG. 6.

In addition, if the optical amplification is not needed for the transmission light (No at Step S41), the control unit 56A controls the second optical switch 55 in order to switch over to the path between the transmission side isolator 52 and the first optical switch 54 (Step S44). Furthermore, the control unit 56A controls the first optical switch 54 in order to switch over to the path between the transmission side input 41 and the second optical switch 55 (Step S45), and ends the FIG. 6 processing operation illustrated in.

In the second amplification switching process, if the optical amplification is needed for the transmission light, the transmission light is optically amplified by way of the path route of the transmission side input 41→the first optical switch 54→the optical amplification element 51A→the transmission side isolator 52→the transmission side output 43. Consequently, it is possible to output stable transmission light even when the transmission light is attenuated due to long distance transmission.

In the second amplification switching process, if the optical amplification is not needed for the transmission light, the transmission light is output by way of the path route of the transmission side input 41→the first optical switch 54→the second optical switch 55→the transmission side isolator 52→the transmission side output 43. Consequently, it is possible to reduce the electrical power consumption needed for the optical amplification.

In the optical amplifier 50A according to the second embodiment, it is possible to perform the optical amplification on the reception light and the transmission light by using the single unit of the optical amplification element 51A that is disposed on the transmission path, so that there is no need to prepare a new optical amplification element, and it is thus possible to greatly contribute to a reduction in the size of a communication module having the optical amplifier 50A as a built-in unit.

The optical amplifier 50 controls the second optical switch 55 such that the path between the optical amplification element 51A and the transmission side output 43 is switched to the path between the reception side input 44 and the optical amplification element 51A. The optical amplifier 50 controls the first optical switch 54 such that the path between the transmission side input 41 and the optical amplification element 51A is switched to the path between the optical amplification element 51A and the reception side output 42. Consequently, it is possible to share the single unit of the optical amplification element 51A located on the transmission path in order to perform the optical amplification on the transmission light and the reception light.

In the following, an embodiment of a communication module 1 that includes the optical amplifier 50A as a built-in unit according to the second embodiment will be described as a third embodiment.

### (c) Third Embodiment

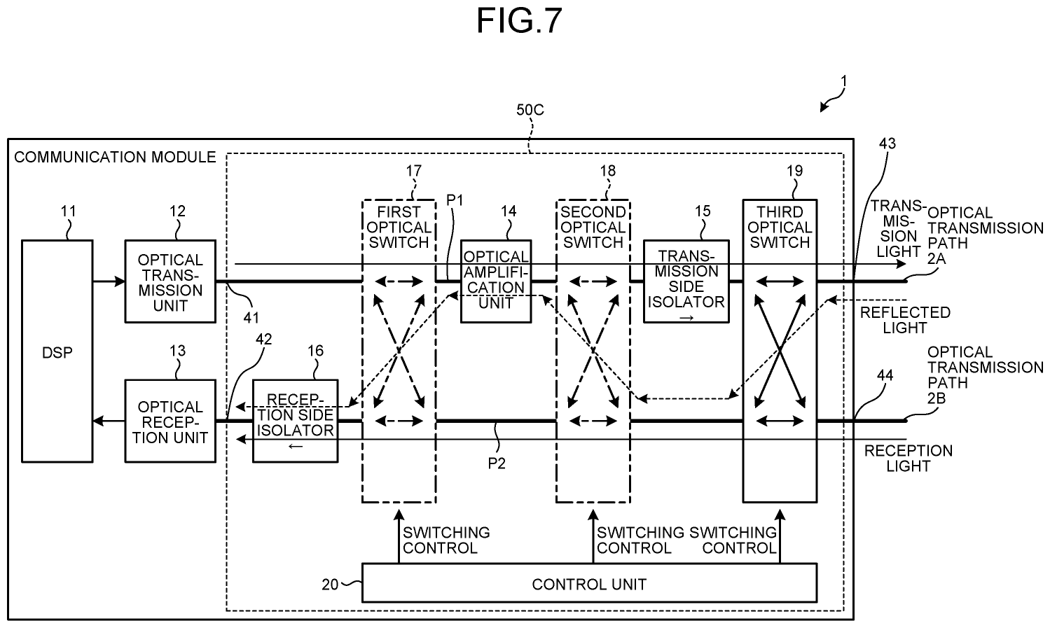

FIG. 7 is a diagram illustrating one example of a configuration of the communication module 1 according to the third embodiment. The communication module 1 illustrated in FIG. 7 is optically connected to an optical transmission path 2A that is disposed on the transmission side, and is optically connected to an optical transmission path 2B that is disposed on the reception side.

The communication module 1 includes a digital signal processor (DSP) 11, an optical transmission unit 12, an optical reception unit 13, and an optical amplifier 50C. The DSP 11 is a processor that generates transmission data and that executes signal processing to acquire reception data. The optical transmission unit 12 performs optical conversion on the transmission data received from the DSP 11, and then generates transmission light. The optical reception unit 13 performs electric conversion on the received reception light and then acquires reception data.

The optical amplifier 50C includes an optical amplification unit 14, a transmission side isolator 15, a reception side isolator 16, a first optical switch 17, a second optical switch 18, a third optical switch 19, and a control unit 20. The optical amplification unit 14 is arranged on the transmission path and optically amplifies the passing signal light. In addition, for convenience of description, the transmission path on which the optical amplification unit 14 is arranged and that is located between the transmission side input 41 that is connected to the optical transmission unit 12 and the transmission side output 43 that is connected to the optical transmission path 2A disposed on the transmission side is denoted by P1. Furthermore, the reception path on which the optical amplification unit 14 is not arranged and that is located between the reception side input 44 that is connected to the optical transmission path 2B disposed on the reception side and the reception side output 42 that is connected to the optical reception unit 13 is denoted by P2. The transmission side isolator 15 allows transmission of the signal light travelling in the forward direction (transmission direction), and blocks the signal light travelling in the inverse direction (reception direction). The reception side isolator 16 allows transmission of the signal light travelling in the forward direction (reception direction), and blocks the signal light travelling in the inverse direction (transmission direction).

The first optical switch 17 is an optical switch that switches each of the paths. These paths include a path that connects between the optical transmission unit 12 and the optical amplification unit 14, and a path that connects between the optical transmission unit 12 and the second optical switch 18. These paths include a path that connects between the reception side isolator 16 and the optical amplification unit 14, and a path that connects between the reception side isolator 16 and the second optical switch 18.

The second optical switch 18 is an optical switch that switches each of the paths. These paths include a path that connects between the optical amplification unit 14 and the transmission side isolator 15, and a path that connects between the optical amplification unit 14 and the third optical switch 19. These paths include a path that connects between the first optical switch 17 and the third optical switch 19, and a path that connects between the transmission side isolator 15 and the first optical switch 17.

The third optical switch 19 switches the paths from among the path that connects between the transmission side isolator 15 and the optical transmission path 2A that is disposed on the transmission side, the path that connects between the optical transmission path 2B that is disposed on the reception side and the second optical switch 18, and the path that connects between the optical transmission path 2A that is disposed on the transmission side and the second optical switch 18.

The control unit 20 performs switching control on the first optical switch 17, the second optical switch 18, and the third optical switch 19. The control unit 20 determines whether or not the optical amplification unit 14 is needed in accordance with the transmission distance of, for example, the optical transmission path 2A that is disposed on the transmission side or the optical transmission path 2B that is disposed on the reception side, and then controls, on the basis of the determination result, the first optical switch 17, the second optical switch 18, and the third optical switch 19. If the transmission distance of the optical transmission path 2A that is disposed on the transmission side and that is connected to the transmission side output 43 is a long distance, the control unit 20 determines that the optical amplification unit 14 is needed, whereas, if the transmission distance of the optical transmission path 2A disposed on the transmission side is a short distance, the control unit 20 determines that the optical amplification unit 14 is not needed. If the transmission distance of the optical transmission path 2B that is disposed on the reception side and that is connected to the reception side input 44 is a long distance, the control unit 20 determines that the optical amplification unit 14 is needed, and, if the transmission distance of the optical transmission path 2B disposed on the reception side is a short distance, the control unit 20 determines that determines that the optical amplification unit 14 is not needed.

First, an operation of the communication module 1 performed when the transmission light that has been input from the optical transmission unit 12 is optically amplified and is output to the optical transmission path 2A disposed on the transmission side will be described. The control unit 20 determines that the optical amplification unit 14 is needed in the case where, for example, the transmission distance of the optical transmission path 2A disposed on the transmission side is a long distance. Then, the control unit 20 controls the first optical switch 17 in order to switch over to the path between the optical transmission unit 12 and the optical amplification unit 14. Furthermore, the control unit 20 controls the second optical switch 18 in order to switch over to the path between the optical amplification unit 14 and the transmission side isolator 15. Furthermore, the control unit 20 controls the third optical switch 19 in order to switch over to the path between the transmission side isolator 15 and the optical transmission path 2A that is disposed on the transmission side. Consequently, a path along the path route of the optical transmission unit 12→the first optical switch 17→the optical amplification unit 14→the second optical switch 18→the transmission side isolator 15→the third optical switch 19→the optical transmission path 2A disposed on the transmission side is formed.

The optical transmission unit 12 outputs the transmission light that has been optically amplified by the optical amplification unit 14 to the optical transmission path 2A that is disposed on the transmission side by way of the path route of the first optical switch 17→the optical amplification unit 14→the second optical switch 18→the transmission side isolator 15→the third optical switch 19.

An operation of the communication module 1 performed when the reception light that has been input from the optical transmission path 2B that is disposed on the reception side is optically amplified and is output to the optical reception unit 13 will be described. The control unit 20 determines that the optical amplification unit 14 is needed in the case where, for example, the transmission distance of the optical transmission path 2B disposed on the reception side is a long distance. Then, the control unit 20 controls the first optical switch 17 in order to switch over to the path between the reception side isolator 16 and the optical amplification unit 14. The control unit 20 controls the second optical switch 18 in order to switch over to the path between the optical amplification unit 14 and the third optical switch 19. The control unit 20 controls the third optical switch 19 in order to switch over to the path between the second optical switch 18 and the optical transmission path 2B that is disposed on the reception side. Consequently, a path along the path route of the optical transmission path 2B disposed on the reception side→the third optical switch 19→the second optical switch 18→the optical amplification unit 14→the first optical switch 17→the reception side isolator 16→the optical reception unit 13 is formed.

The optical reception unit 13 obtains the reception light that has been amplified by the optical amplification unit 14 by way of the path route of the optical transmission path 2B disposed on the reception side→the third optical switch 19→the second optical switch 18→the optical amplification unit 14→the first optical switch 17→the reception side isolator 16.

An operation of the communication module 1 performed when the transmission light that has been input from the optical transmission unit 12 is transmitted without being amplified and is output to the optical transmission path 2A that is disposed on the transmission side will be described. The control unit 20 determines that the optical amplification unit 14 is not needed in the case where, for example, the transmission distance of the optical transmission path 2A that is disposed on the transmission side is a short distance. Then, the control unit 20 controls the first optical switch 17 in order to switch over to the path between the optical transmission unit 12 and the second optical switch 18. The control unit 20 controls the second optical switch 18 in order to switch over to the path between the first optical switch 17 and the third optical switch 19. Then, the control unit 20 controls the third optical switch 19 in order to switch over to the path between the second optical switch 18 and the optical transmission path 2A that is disposed on the transmission side. Consequently, a path along the path route of the optical transmission unit 12→the first optical switch 17→the second optical switch 18→the transmission side isolator 15→the third optical switch 19→the optical transmission path 2A disposed on the transmission side is formed.

The optical transmission unit 12 outputs the transmission light to the optical transmission path 2A that is disposed on the transmission side by way of the path route of the first optical switch 17→the second optical switch 18→the third optical switch 19. Consequently, the optical amplification unit 14 is not used, so that it is possible to reduce electrical power consumption at the time at which the transmission light is transmitted.

An operation of the communication module 1 performed when the reception light that has been input from the optical transmission path 2B that is disposed on the reception side is transmitted without being amplified and is output to the optical reception unit 13 will be described. The control unit 20 determines that the optical amplification unit 14 is not needed in the case where, for example, the transmission distance is a short distance. Then, the control unit 20 controls the first optical switch 17 in order to switch over to the path between the reception side isolator 16 and the second optical switch 18. The control unit 20 controls the second optical switch 18 in order to switch over to the path between the first optical switch 17 and the third optical switch 19. The control unit 20 controls the third optical switch 19 in order to switch over to the path between the second switch and the optical transmission path 2B that is disposed on the reception side. Consequently, a path along the path route of the optical transmission path 2B disposed on the reception side→the third optical switch 19→the second optical switch 18→the first optical switch 17→the reception side isolator 16→the optical reception unit 13 is formed.

The optical reception unit 13 obtains the reception light by way of the path route of the optical transmission path 2B disposed on the reception side→the third optical switch 19→the second optical switch 18→the first optical switch 17→the reception side isolator 16. Consequently, the optical amplification unit 14 is not used, so that it is possible to reduce the electrical power consumption at the time at which the reception light is received.

In addition, the DSP 11 has an optical time domain reflectometer (OTDR) function for measuring the distance to the communication device provided on the destination side or to a fault location located on the optical transmission path 2A that is disposed on the transmission side. The OTDR function transmits pulse light to the optical transmission path 2A that is disposed on the transmission side by using the optical transmission unit 12, and receives reflected light with respect to the pulse light from the optical transmission path 2A that is disposed on the transmission side by using the optical reception unit 13. Consequently, the OTDR function measures, by using the reflected light received by the optical reception unit 13, the distance to the communication device that is provided on the destination side and that is located on the optical transmission path 2A that is disposed on the transmission side and the distance to the fault location on the optical transmission path 2A that is disposed on the transmission side.

In the following, an operation of the communication module 1 that performs the OTDR function will be described. If the control unit 20 detects activation of the OTDR function, the control unit 20 controls the first optical switch 17 in order to switch over to the path between the optical transmission unit 12 and the optical amplification unit 14. Furthermore, the control unit 20 controls the second optical switch 18 in order to switch over to the path between the optical amplification unit 14 and the transmission side isolator 15. Furthermore, the control unit 20 performs control the third optical switch 19 in order to switch over to the path between the transmission side isolator 15 and the optical transmission path 2A that is disposed on the transmission side. Consequently, a path along the path route of the optical transmission unit 12→the first optical switch 17→the optical amplification unit 14→the second optical switch 18→the transmission side isolator 15→the third optical switch 19→the optical transmission path 2A disposed on the transmission side is formed.

The optical transmission unit 12 outputs the pulse light that is used for the OTDR function and that is to be optically amplified by the optical amplification unit 14 to the optical transmission path 2A that is disposed on the transmission side by way of the path route of the first optical switch 17→the optical amplification unit 14→the second optical switch 18→the transmission side isolator 15→the third optical switch 19.

If the transmission of the pulse light from the third optical switch 19 to the optical transmission path 2A that is disposed on the transmission side has been completed, the control unit 20 controls the first optical switch 17 in order to switch over to the path between the reception side isolator 16 and the optical amplification unit 14. The control unit 20 controls the second optical switch 18 in order to switch over to the path between the optical amplification unit 14 and the third optical switch 19. The control unit 20 controls the third optical switch 19 in order to switch over to the path between the optical transmission path 2A that is disposed on the transmission side and the second optical switch 18. Consequently, a path along the path route of the optical transmission path 2A disposed on the transmission side→the third optical switch 19→the second optical switch 18→the optical amplification unit 14→the first optical switch 17→the reception side isolator 16→the optical reception unit 13 is formed.

The optical reception unit 13 obtains the reflected light that is reflected with respect to the pulse light, that is used for the OTDR function, and that has been amplified by the optical amplification unit 14 by way of the path route of the optical transmission path 2A disposed on the transmission side→the third optical switch 19→the second optical switch 18→the optical amplification unit 14→the first optical switch 17→the reception side isolator 16. Then, the DSP 11 performs the OTDR function on the basis of the reflected light received by the optical reception unit 13.

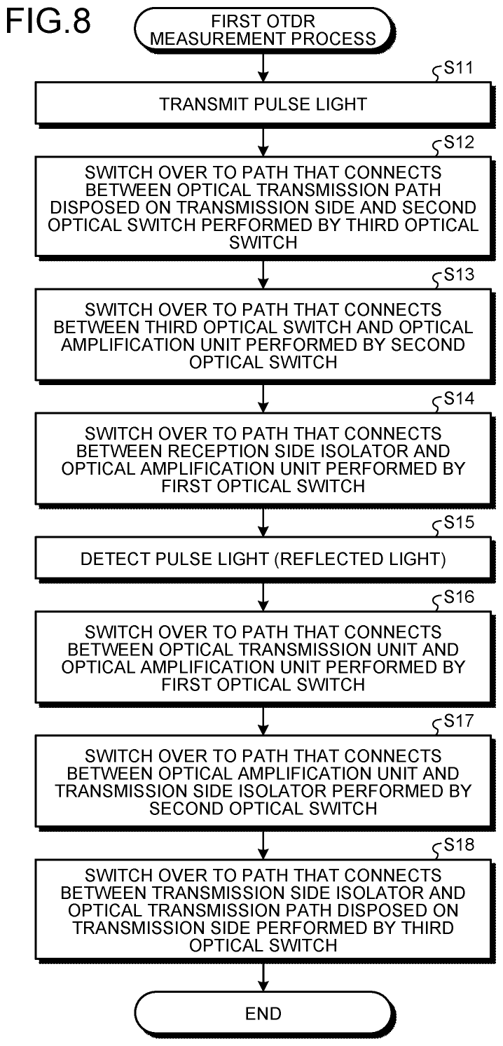

FIG. 8 is a flowchart illustrating one example of the processing operation related to a first OTDR measurement process performed by the control unit 20. In FIG. 8, the control unit 20 forms a path along the path route of the optical transmission unit 12→the first optical switch 17→the optical amplification unit 14→the second optical switch 18→the transmission side isolator 15→the third optical switch 19→the optical transmission path 2A disposed on the transmission side. After having generated the path, the control unit 20 transmits the pulse light that is used for the OTDR from the optical transmission unit 12 (Step S11).

After having transmitted the pulse light, the control unit 20 controls the third optical switch 19 in order to switch over to the path between the optical transmission path 2A that is disposed on the transmission side and the second optical switch 18 (Step S12). The control unit 20 controls the second optical switch 18 in order to switch over to the path between the optical amplification unit 14 and the third optical switch 19 (Step S13). The control unit 20 controls the first optical switch 17 in order to switch over to the path between the reception side isolator 16 and the optical amplification unit 14 (Step S14).

If the control unit 20 detects reflected light by way of the optical reception unit 13 (Step S15), the control unit 20 controls the first optical switch 17 in order to switch over to the path between the optical transmission unit 12 and the optical amplification unit 14 (Step S16). Furthermore, the control unit 20 controls the second optical switch 18 in order to switch over to the path between the optical amplification unit 14 and the transmission side isolator 15 (Step S17). Furthermore, the control unit 20 controls the third optical switch 19 in order to switch over to the path between the transmission side isolator 15 and the optical transmission path 2A that is disposed on the transmission side (Step S18), and ends the processing operation illustrated in FIG. 8. Consequently, the control unit 20 forms a path along the path route of the optical transmission unit 12→the first optical switch 17→the optical amplification unit 14→the second optical switch 18→the transmission side isolator 15→the third optical switch 19→the optical transmission path 2A disposed on the transmission side.

The communication module 1 according to the third embodiment switches optical amplification between the reception light and the transmission light by using the single unit of the optical amplification unit 14 that is disposed on the transmission path, so that there is no need to prepare a new optical amplification element, and it is thus possible to greatly contribute to a reduction in the size of the communication module 1 that includes the optical amplification unit as a built-in unit.

The communication module 1 controls the third optical switch 19 such that the path between the transmission side isolator 15 and the optical transmission path 2A that is disposed on the transmission side is switched to the path between the optical transmission path 2B that is disposed on the reception side and the second optical switch 18. The communication module 1 controls the second optical switch 18 such that the path between the optical amplification unit 14 and the transmission side isolator 15 is switched to the path between the third optical switch 19 and the optical amplification unit 14. Furthermore, the communication module 1 controls the first optical switch 17 such that the path between the optical transmission unit 12 and the optical amplification unit 14 is switched to the path between the optical amplification unit 14 and the reception side isolator 16. Consequently, it is possible to implement optical amplification to be performed on the transmission light and the reception light in a switching manner by using the single unit of the optical amplification unit 14 that is disposed on the transmission path.

The communication module 1 detects reflected light with respect to the pulse light from the optical transmission path 2A that is disposed on the transmission side and that has the OTDR function. When the communication module 1 detects the reflected light, the communication module 1 controls the third optical switch 19 such that the path between the transmission side isolator 15 and the optical transmission path 2A that is disposed on the transmission side is switched to the path between the optical transmission path 2A that is disposed on the transmission side and the second optical switch 18. The communication module 1 controls the second optical switch 18 such that the path between the optical amplification unit 14 and the transmission side isolator 15 is switched to the path between the third optical switch 19 and the optical amplification unit 14. The communication module 1 controls the first optical switch 17 such that the path between the optical transmission unit 12 and the optical amplification unit 14 is switched to the path between the optical amplification unit 14 and the reception side isolator 16. Consequently, it is possible to implement the OTDR function in long distance transmission by amplifying the reflected light using the single unit of the optical amplification unit 14 that is disposed on the transmission path.

If the transmission distance is a short distance, the communication module 1 controls the third optical switch 19 such that the path between the second optical switch 18 and the optical transmission path 2A that is disposed on the transmission side is connected. The communication module 1 controls the second optical switch 18 such that the path between the optical amplification unit 14 and the transmission side isolator 15 is switched to the path between the first optical switch 17 and the third optical switch 19. The communication module 1 controls the first optical switch 17 such that the path between the optical transmission unit 12 and the optical amplification unit 14 is switched to the path between the second optical switch 18 and the reception side isolator 16. Consequently, it is possible to reduce the electrical power consumption caused by the optical amplification unit 14 in the case where the transmission distance of the optical transmission path 2B disposed on the reception side is a short distance.

In addition, for convenience of description, a case has been described as an example in which the control unit 20 determines whether or not the optical amplification unit 14 is needed in accordance with the transmission distance of the optical transmission path 2A disposed on the transmission side or the optical transmission path 2B disposed on the reception side, and, if the optical amplification unit 14 is not needed, the path is switched to the path that does not pass through the optical amplification unit 14. However, the control unit 20 may adjust the optical output power of the optical transmission unit 12 and the amplification factor of the optical amplification unit 14 in accordance with the transmission distance even when the optical amplification unit 14 is needed or is not needed in accordance with the transmission distance, and appropriate modifications are possible. In addition, for convenience of description, a case has been described as an example in which the control unit does not use the optical amplification unit in the case where the transmission distance is a short distance, whereas the control unit uses the optical amplification unit in the case where the transmission distance is a long distance. However, the control unit may adjust the optical output power of the optical transmission unit 12 and the amplification factor of the optical amplification unit 14 in accordance with the transmission distance by using the optical amplification unit or without using the optical amplification unit in the where the distance is a middle distance between a short distance and a long distance.

### (d) Fourth Embodiment

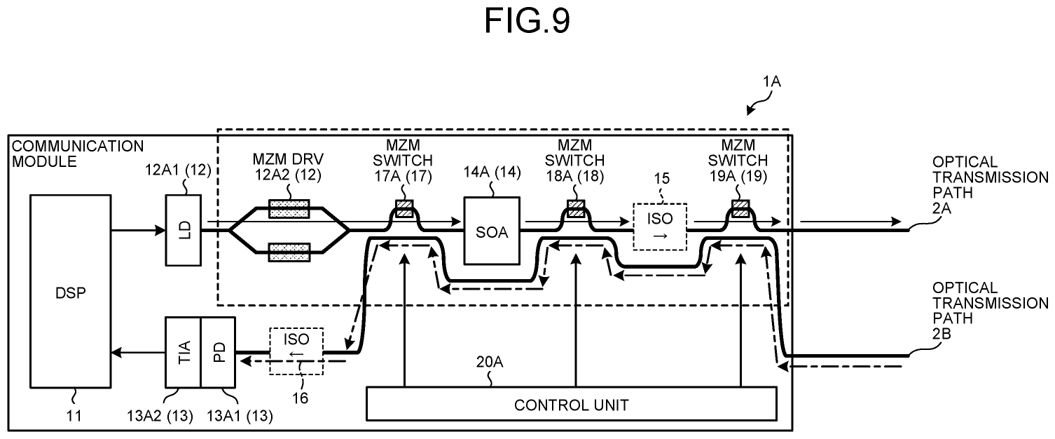

In the following, an embodiment indicating one example of the hardware of the communication module 1 according to the third embodiment will be described as a fourth embodiment. FIG. 9 is a diagram illustrating one example of a configuration of a communication module 1A according to the fourth embodiment. In addition, by assigning the same reference numerals to components having the same configuration as those in the communication module 1 according to the third embodiment, overlapped descriptions of the configuration and the operation thereof will be omitted.

The optical transmission unit 12 included in the communication module 1A illustrated in FIG. 9 includes a laser diode (LD) 12A1 and a Mach-Zehnder modulator (MZM) 12A2. The optical reception unit 13 includes a photo diode (PD) 13A1 and a Transimpedance Amplifier (TIA) 13A2. The optical amplification unit 14 is constituted by, for example, a semiconductor optical amplifier (SOA) 14A.

The transmission side isolator 15 is, for example, an isolator (ISO). The reception side isolator 16 is an isolator (ISO). The first optical switch 17 is constituted of, for example, a MZM switch 17A. The second optical switch 18 is constituted by, for example, a MZM switch 18A. The third optical switch 19 is constituted by, for example, a MZM switch 19A. The MZM 12A2, the MZM switch 17A, the MZM switch 18A, and the MZM switch 19A are formed by using the silicon photonics technology. A control unit 20A included in the communication module 1A performs switching control on the MZM switch 17A, the MZM switch 18A, and the MZM switch 19A.

In the communication module 1A according to the fourth embodiment, optical amplification of reception light and optical amplification of transmission light is switched by using a single unit of the SOA 14A that is disposed on the transmission path, so that there is no need to prepare a new SOA, and it is thus possible to greatly contribute to a reduction in the size of the communication module 1 having the SOA as a built-in unit. In addition, the MZM 12A2, the MZM switch 17A, the MZM switch 18A, and the MZM switch 19A are formed by using the silicon photonics technology, so that it is possible to greatly contribute to a reduction in the size of the communication module 1A.

In addition, the communication module 1 according to the third embodiment, a case has been described as an example in which the optical amplification unit 14 is arranged on the transmission path; however, the example is not limited to this, and, for example, the optical amplification unit 14 may be arranged on the reception path. An embodiment thereof will be described below as a fifth embodiment.

### (e) Fifth Embodiment

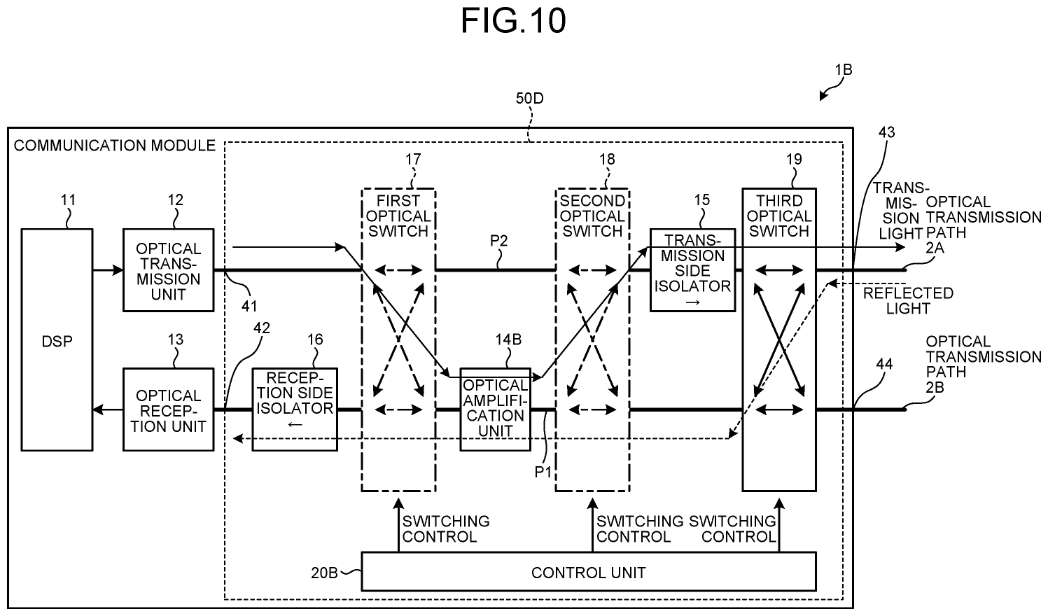

FIG. 10 is a diagram illustrating one example of a configuration of a communication module 1B according to the fifth embodiment. In addition, by assigning the same reference numerals to components having the same configuration as those in the optical amplification unit 14 according to the first embodiment, overlapped descriptions of the configuration and the operation thereof will be omitted. The communication module 1B illustrated in FIG. 10 is different from the communication module 1 according to the third embodiment in that, instead of the optical amplification unit 14 arranged on the transmission path, an optical amplification unit 14B is arranged on the reception path. In addition, for convenience of description, a reception path on which the optical amplification unit 14B is arranged and that is disposed between the reception side input 44 that is connected to the optical transmission path 2B disposed on the reception side and the reception side output 42 that is connected to the optical reception unit 13 is denoted by P1. Furthermore, a transmission path on which the optical amplification unit 14B is not arranged and that is disposed between the transmission side input 41 that is connected to the optical transmission unit 12 and the transmission side output 43 that is connected to the optical transmission path 2A that is disposed on the transmission side is denoted by P2.

An optical amplifier 50D included in the communication module 1B includes the optical amplification unit 14B, the transmission side isolator 15, the reception side isolator 16, the first optical switch 17, the second optical switch 18, the third optical switch 19, and a control unit 20B. The optical amplification unit 14B is arranged on the reception path and optically amplifies signal light.

The first optical switch 17 is an optical switch that switches each of the paths. These paths include a path that connects between the optical transmission unit 12 and the optical amplification unit 14B, and a path that connects between the optical transmission unit 12 and the second optical switch 18. These paths include a path that connects between the reception side isolator 16 and the optical amplification unit 14B, and a path that connects between the reception side isolator 16 and the second optical switch 18.

The second optical switch 18 is an optical switch that switches each of the paths. These paths include a path that connects between the optical amplification unit 14B and the transmission side isolator 15, and a path that connects between the optical amplification unit 14B and the third optical switch 19. These paths include a path that connects between the first optical switch 17 and the third optical switch 19, and a path that connects between the transmission side isolator 15 and the first optical switch 17.

The third optical switch 19 switches among a path that connects between the transmission side isolator 15 and the optical transmission path 2A that is disposed on the transmission side, a path that connects between the optical transmission path 2B that is disposed on the reception side and the second optical switch 18, and a path that connects between the optical transmission path 2A that is disposed on the transmission side and the second optical switch 18.

The control unit 20B performs switching control on the first optical switch 17, the second optical switch 18, and the third optical switch 19. The control unit 20B determines whether or not the optical amplification unit 14B is needed in accordance with the transmission distance, and controls the first optical switch 17, the second optical switch 18, and the third optical switch 19 on the basis of the determination result. The control unit 20B determines that the optical amplification unit 14B is needed in the case where the transmission distance of the optical transmission path 2A that is disposed on the transmission side and that is connected to the transmission side output 43 is a long distance, whereas the control unit 20B determines that the optical amplification unit 14B is not needed in the case where the transmission distance of the optical transmission path 2A that is disposed on the transmission side is a short distance. The control unit 20B determines that the optical amplification unit 14B is needed in the case where the transmission distance of the optical transmission path 2B that is disposed on the reception side and that is connected to the reception side input 44 is a long distance, whereas the control unit 20B determines that the optical amplification unit 14B is not needed in the case where the transmission distance of the optical transmission path 2B that is disposed on the reception side is a short distance.

First, an operation of the communication module 1B performed when the transmission light received from the optical transmission unit 12 is optically amplified and is then output to the optical transmission path 2A that is disposed on the transmission side will be described. The control unit 20B determines that the optical amplification unit 14B is needed in the case where, for example, the transmission distance of the optical transmission path 2A that is disposed on the transmission side is a long distance. Then, the control unit 20B controls the first optical switch 17 in order to switch over to the path between the optical transmission unit 12 and the optical amplification unit 14B. Furthermore, the control unit 20B controls the second optical switch 18 in order to switch over to the path between the optical amplification unit 14B and the transmission side isolator 15. Furthermore, the control unit 20B controls the third optical switch 19 in order to switch over to the path between the transmission side isolator 15 and the optical transmission path 2A that is disposed on the transmission side. Consequently, a path along the path route of the optical transmission unit 12→the first optical switch 17→the optical amplification unit 14B→the second optical switch 18→the transmission side isolator 15→the third optical switch 19→the optical transmission path 2A disposed on the transmission side is formed.

The optical transmission unit 12 outputs the transmission light that has been optically amplified by the optical amplification unit 14B to the optical transmission path 2A that is disposed on the transmission side by way of the path route of the first optical switch 17→the optical amplification unit 14B→the second optical switch 18→the transmission side isolator 15→the third optical switch 19.

An operation of the communication module 1B performed when the reception light received from the optical transmission path 2B disposed on the reception side is optically amplified and is output to the optical reception unit 13 will be described. The control unit 20B determines that the optical amplification unit 14B in the case where, for example, the transmission distance of the optical transmission path 2B that is disposed on the reception side is a long distance. Then, the control unit 20B controls the first optical switch 17 in order to switch over to the path between the reception side isolator 16 and the optical amplification unit 14B. The control unit 20B controls the second optical switch 18 in order to switch over to the path between the optical amplification unit 14B and the third optical switch 19. The control unit 20B controls the third optical switch 19 in order to switch over to the path between the second optical switch 18 and the optical transmission path 2B that is disposed on the reception side. Consequently, a path along the path route of the optical transmission path 2B disposed on the reception side→the third optical switch 19→the second optical switch 18→the optical amplification unit 14B→the first optical switch 17→the reception side isolator 16→the optical reception unit 13 is formed.

The optical reception unit 13 obtains the reception light that has been amplified by the optical amplification unit 14B by way of the path route of the optical transmission path 2B disposed on the reception side→the third optical switch 19→the second optical switch 18→the optical amplification unit 14B→the first optical switch 17→the reception side isolator 16.

An operation of the communication module 1B performed when the transmission light that is input from the optical transmission unit 12 is transmitted without being amplified and is output to the optical transmission path 2A that is disposed on the transmission side will be described. The control unit 20B determines that the optical amplification unit 14B is not needed in the case where, for example, the transmission distance of the optical transmission path 2A that is disposed on the transmission side is a short distance. Then, the control unit 20B controls the first optical switch 17 in order to switch over to the path between the optical transmission unit 12 and the second optical switch 18. The control unit 20B controls the second optical switch 18 in order to switch over to the path between the first optical switch 17 and the third optical switch 19. Then, the control unit 20B controls the third optical switch 19 in order to switch over to the path between the second optical switch 18 and the optical transmission path 2A that is disposed on the transmission side. Consequently, a path along the path route of the optical transmission unit 12→the first optical switch 17→the second optical switch 18→the third optical switch 19→the optical transmission path 2A disposed on the transmission side is formed.

The optical transmission unit 12 outputs the transmission light to the optical transmission path 2A that is disposed on the transmission by way of the path route of the first optical switch 17→the second optical switch 18→the third optical switch 19. Consequently, the optical amplification unit 14B is not used, so that it is possible to reduce electrical power consumption at the time at which the transmission light is transmitted.

An operation of the communication module 1B performed when the reception light that is input from the optical transmission path 2B disposed on the reception side is transmitted without being amplified and is output to the optical reception unit 13 will be described. The control unit 20B determines that the optical amplification unit 14B is not needed in the case where, for example, the transmission distance of the optical transmission path 2B disposed on the reception side is a short distance. Then, the control unit 20B controls the first optical switch 17 in order to switch over to the path between the reception side isolator 16 and the second optical switch 18. The control unit 20B controls the second optical switch 18 in order to switch over to the path between the first optical switch 17 and the third optical switch 19. The control unit 20B controls the third optical switch 19 in order to switch over to the path between the second switch and the optical transmission path 2B that is disposed on the reception side. Consequently, a path along the path route of the optical transmission path 2B disposed on the reception side→the third optical switch 19→the second optical switch 18→the first optical switch 17→the reception side isolator 16→the optical reception unit 13 is formed.

The optical reception unit 13 obtains the reception light by way of the path route of the optical transmission path 2B disposed on the reception side→the third optical switch 19→the second optical switch 18→the first optical switch 17→the reception side isolator 16. Consequently, the optical amplification unit 14B is not used, so that it is possible to reduce electrical power consumption at the time at which the reception light is received.

In the following, an operation of the communication module 1B that performs the OTDR function will be described. If the control unit 20B detects activation of the OTDR function, the control unit 20B controls the first optical switch 17 in order to switch over to the path between the optical transmission unit 12 and the optical amplification unit 14B. Furthermore, the control unit 20B controls the second optical switch 18 in order to switch over to the path between the optical amplification unit 14B and the transmission side isolator 15. Furthermore, the control unit 20B controls the third optical switch 19 in order to switch over to the path between the transmission side isolator 15 and the optical transmission path 2A that is disposed on the transmission side. Consequently, a path along the path route of the optical transmission unit 12→the first optical switch 17→the optical amplification unit 14B→the second optical switch 18→the transmission side isolator 15→the third optical switch 19→the optical transmission path 2A disposed on the transmission side is formed.

The optical transmission unit 12 outputs the pulse light that is used for the OTDR function and that is to be optically amplified by the optical amplification unit 14B to the optical transmission path 2A that is disposed on the transmission side by way of the path route of the first optical switch 17→the optical amplification unit 14B→the second optical switch 18→the transmission side isolator 15→the third optical switch 19.

If the transmission of the pulse light from the third optical switch 19 to the optical transmission path 2A that is disposed on the transmission side has been completed, the control unit 20B controls the first optical switch 17 in order to switch over to the path between the reception side isolator 16 and the optical amplification unit 14B. The control unit 20B controls the second optical switch 18 in order to switch over to the path between the optical amplification unit 14B and the third optical switch 19. The control unit 20B controls the third optical switch 19 in order to switch over to the path between the optical transmission path 2A that is disposed on the transmission side and the second optical switch 18. Consequently, a path along the path route of the optical transmission path 2A disposed on the transmission side→the third optical switch 19→the second optical switch 18→the optical amplification unit 14B→the first optical switch 17→the reception side isolator 16→the optical reception unit 13 is formed.

The optical reception unit 13 obtains the reflected light that is reflected with respect to the pulse light, that is used for the OTDR function, and that has been amplified by the optical amplification unit 14B by way of the path route of the optical transmission path 2A disposed on the transmission side→the third optical switch 19→the second optical switch 18→the optical amplification unit 14B→the first optical switch 17→the reception side isolator 16. Then, the DSP 11 performs the OTDR function on the basis of the reflected light received by the optical reception unit 13.

The communication module 1B according to the fifth embodiment switches optical amplification between the reception light and the transmission light by using the single unit of the optical amplification unit 14B that is disposed on the reception path, so that there is no need to prepare a new optical amplification element, and it is thus possible to greatly contribute to a reduction in the size of the communication module 1B that includes the optical amplification unit as a built-in unit.

The communication module 1B controls the third optical switch 19 such that the path between the transmission side isolator 15 and the optical transmission path 2A that is disposed on the transmission side is switched to the path between the optical transmission path 2B that is disposed on the reception side and the second optical switch 18. The communication module 1B controls the second optical switch 18 such that the path between the first optical switch 17 and the transmission side isolator 15 is switched to the path between the third optical switch 19 and the optical amplification unit 14B. Furthermore, the communication module 1B controls the first optical switch 17 such that the path between the optical transmission unit 12 and the optical amplification unit 14B is switched to the path between the optical amplification unit 14B and the reception side isolator 16. Consequently, it is possible to implement optical amplification to be performed on the transmission light and the reception light in a switching manner by using the single unit of the optical amplification unit 14B that is disposed on the reception path.

The communication module 1B detects reflected light with respect to the pulse light from the optical transmission path 2A that is disposed on the transmission side and that has the OTDR. When the communication module 1B detects the reflected light, the communication module 1B controls the third optical switch 19 such that the path between the transmission side isolator 15 and the optical transmission path 2A that is disposed on the transmission side is switched to the path between the optical transmission path 2A that is disposed on the transmission side and the second optical switch 18. The communication module 1B controls the second optical switch 18 such that the path between the optical amplification unit 14B and the transmission side isolator 15 is switched to the path between the third optical switch 19 and the optical amplification unit 14B. The communication module 1B controls the first optical switch 17 such that the path between the optical transmission unit 12 and the optical amplification unit 14B is switched to the path between the optical amplification unit 14B and the reception side isolator 16. Consequently, it is possible to implement the OTDR function in long distance transmission by amplifying the reflected light using the single unit of the optical amplification unit 14B that is disposed on the reception path.

If the transmission distance is a short distance, the communication module 1B controls the third optical switch 19 such that the path between the second optical switch 18 and the optical transmission path 2A that is disposed on the transmission side is connected. The communication module 1B controls the second optical switch 18 such that the path between the optical amplification unit 14B and the transmission side isolator 15 is switched to the path between the first optical switch 17 between the third optical switch 19. The communication module 1B controls the first optical switch 17 such that the path between the optical transmission unit 12 and the optical amplification unit 14B is switched to the path between the second optical switch 18 and the reception side isolator 16. Consequently, it is possible to reduce the electrical power consumption caused by the optical amplification unit 14B in the case where the transmission distance of the optical transmission path 2B disposed on the reception side is a short distance.

In addition, a case has been described as an example in which the communication module 1 according to the third embodiment is constituted by using the different transmission paths between the optical transmission path 2A that is disposed on the transmission side and the optical transmission path 2B that is disposed on the reception side; however, the communication module 1 may be applied to a bidirectional single optical transmission path, and an embodiment thereof will be described below as a sixth embodiment.

### (f) Sixth Embodiment

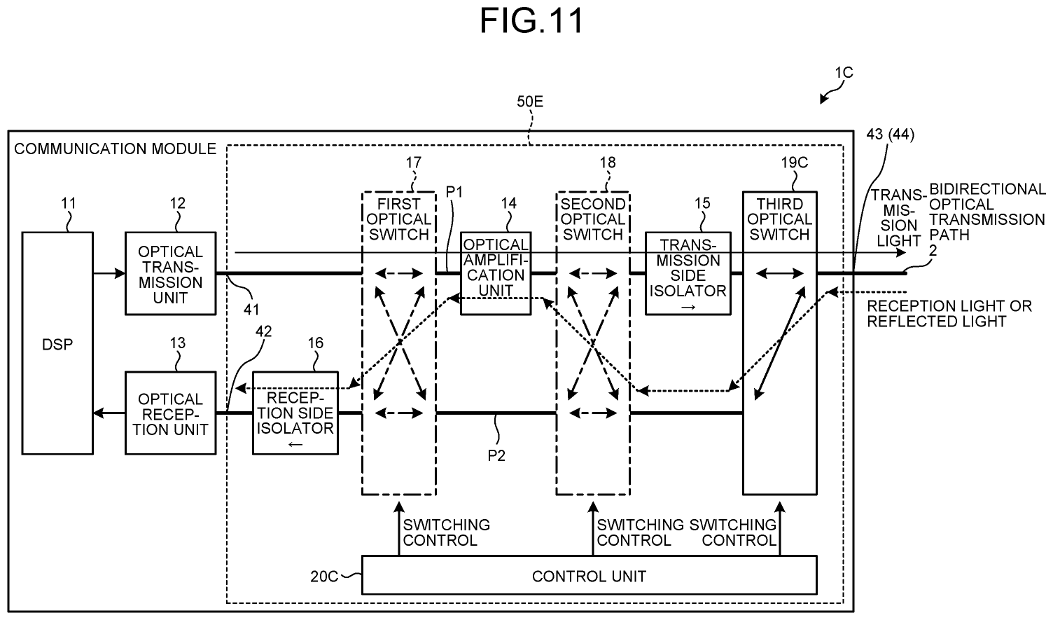

FIG. 11 is a diagram illustrating one example of a communication module 1C according to the sixth embodiment. In addition, by assigning the same reference numerals to components having the same configuration as those in the communication module 1 according to the third embodiment, overlapped descriptions of the configuration and the operation thereof will be omitted. The communication module 1C illustrated in FIG. 11 is different from the communication module 1 according to the third embodiment in that the communication module 1C that is connected to a bidirectional optical transmission path 2.

The communication module 1C that is connected to the bidirectional optical transmission path 2 uses different wavelengths between the transmission light and the reception light, so that it is possible to perform optical amplification by using the single unit of the optical amplification unit 14. An optical amplifier 50E included in the communication module 1C includes the optical amplification unit 14, the transmission side isolator 15, the reception side isolator 16, the first optical switch 17, the second optical switch 18, a third optical switch 19C, and a control unit 20C. The optical amplification unit 14 is arranged on the transmission path and optically amplifies signal light. In addition, for convenience of description, a transmission path on which the optical amplification unit 14 is arranged and that is located between the transmission side input 41 that is connected to the optical transmission unit 12 and the transmission side output 43 that is connected to the bidirectional optical transmission path 2 is denoted by P1. Furthermore, a reception path on which the optical amplification unit 14 is not arranged and that is located between the reception side input 44 that is connected to the bidirectional optical transmission path 2 and the reception side output 42 that is connected to the optical reception unit 13 is denoted by P2.

The third optical switch 19C switches the path that connects between the transmission side isolator 15 and the bidirectional optical transmission path 2 and path that connects between the bidirectional optical transmission path 2 and the second optical switch 18.

The control unit 20C performs switching control on the first optical switch 17, the second optical switch 18, and the third optical switch 19C. The control unit 20C determines whether or not the optical amplification unit 14 is needed in accordance with the transmission distance, and then controls the first optical switch 17, the second optical switch 18, and the third optical switch 19C on the basis of the determination result. The control unit 20C determines that the optical amplification unit 14 is needed in the case where the transmission distance of the bidirectional optical transmission path 2 connected to the transmission side output 43 is a long distance, whereas, the control unit 20C determines that the optical amplification unit 14 is not needed in the case where the transmission distance of the bidirectional optical transmission path 2 is a short distance. The control unit 20C determines that the optical amplification unit 14 is needed in the case where the transmission distance of the bidirectional optical transmission path 2 connected to the reception side input 44 is a long distance, whereas the control unit 20C determines that the optical amplification unit 14 is not needed in the case where the transmission distance of the bidirectional optical transmission path 2 is a short distance.

First, an operation of the communication module 1C performed when the transmission light that has been input from the optical transmission unit 12 is optically amplified and is then output to the bidirectional optical transmission path 2 will be described. The control unit 20C determines that the optical amplification unit 14 is needed in the case where, for example, the transmission distance of the bidirectional optical transmission path 2 is a long distance. Then, the control unit 20C controls the first optical switch 17 in order to switch over to the path between the optical transmission unit 12 and the optical amplification unit 14. Furthermore, the control unit 20C controls the second optical switch 18 in order to switch over to the path between the optical amplification unit 14 and the transmission side isolator 15. Furthermore, the control unit 20C controls the third optical switch 19C in order to switch over to the path between the transmission side isolator 15 and the bidirectional optical transmission path 2. Consequently, a path along the path route of the optical transmission unit 12→the first optical switch 17→the optical amplification unit 14→the second optical switch 18→the transmission side isolator 15→the third optical switch 19C→the bidirectional optical transmission path 2 is formed.

The optical transmission unit 12 outputs the transmission light that has been optically amplified by the optical amplification unit 14 to the bidirectional optical transmission path 2 by way of the path route of the first optical switch 17→the optical amplification unit 14→the second optical switch 18→the transmission side isolator 15→the third optical switch 19C.

An operation of the communication module 1C performed when the reception light that has been input from the bidirectional optical transmission path 2 is optically amplified and is output to the optical reception unit 13 will be described. The control unit 20C determines that the optical amplification unit 14 is needed in the case where, for example, the transmission distance of the bidirectional optical transmission path 2 is a long distance. Then, the control unit 20C controls the first optical switch 17 in order to switch over to the path between the reception side isolator 16 and the optical amplification unit 14. The control unit 20C controls the second optical switch 18 in order to switch over to the path between the optical amplification unit 14 and the third optical switch 19C. The control unit 20C controls the third optical switch 19C in order to switch over to the path between the second optical switch 18 and the bidirectional optical transmission path 2. Consequently, a path along the path route of the bidirectional optical transmission path 2→the third optical switch 19C→the second optical switch 18→the optical amplification unit 14→the first optical switch 17→the reception side isolator 16→the optical reception unit 13 is formed.

The optical reception unit 13 obtains the reception light that has been amplified by the optical amplification unit 14 by way of the path route of the bidirectional optical transmission path 2→the third optical switch 19C→the second optical switch 18→the optical amplification unit 14→the first optical switch 17→the reception side isolator 16.

An operation of the communication module 1C performed when the transmission light that has been input from the optical transmission unit 12 is transmitted without being amplified and is output to the bidirectional optical transmission path 2 will be described. The control unit 20C determines that the optical amplification unit 14 is not needed in the case where, for example, the transmission distance of the bidirectional optical transmission path 2 is a short distance. Then, the control unit 20C controls the first optical switch 17 in order to switch over to the path between the optical transmission unit 12 and the second optical switch 18. The control unit 20C controls the second optical switch 18 in order to switch over to the path between the first optical switch 17 and the third optical switch 19C. Then, the control unit 20C controls the third optical switch 19C in order to switch over to the path between the second optical switch 18 and the bidirectional optical transmission path 2. Consequently, a path along the path route of the optical transmission unit 12→the first optical switch 17→the second optical switch 18→the transmission side isolator 15→the third optical switch 19C→the bidirectional optical transmission path 2 is formed.

The optical transmission unit 12 outputs the transmission light to the bidirectional optical transmission path 2 by way of the path route of the first optical switch 17→the second optical switch 18→the third optical switch 19C. Consequently, the optical amplification unit 14 is not used, so that it is possible to reduce electrical power consumption at the time at which the transmission light is transmitted.

An operation of the communication module 1C performed when the reception light that has been input from the bidirectional optical transmission path 2 is transmitted without being amplified and is output to the optical reception unit 13 will be described. The control unit 20C determines that the optical amplification unit 14 is not needed in the case where, for example, the transmission distance of the bidirectional optical transmission path 2 is a short distance. Then, the control unit 20C controls the first optical switch 17 in order to switch over to the path between the reception side isolator 16 and the second optical switch 18. The control unit 20C controls the second optical switch 18 in order to switch over to the path between the first optical switch 17 and the third optical switch 19C. The control unit 20C controls the third optical switch 19C in order to switch over to the path between the second optical switch 18 and the bidirectional optical transmission path 2. Consequently, a path along the path route of the bidirectional optical transmission path 2→the third optical switch 19C→the second optical switch 18→the first optical switch 17→the reception side isolator 16→the optical reception unit 13 is formed.

The optical reception unit 13 obtains the reception light by way of the path route of the bidirectional optical transmission path 2→the third optical switch 19C→the second optical switch 18→the first optical switch 17→the reception side isolator 16. Consequently, the optical amplification unit 14 is not used, so that it is possible to reduce electrical power consumption at the time at which the reception light is received.

In addition, the DSP 11 has the OTDR function for measuring the distance to the communication device provided on the destination side or the distance to a fault location located on the bidirectional optical transmission path 2. The OTDR function transmits pulse light to the bidirectional optical transmission path 2 by using the optical transmission unit 12, and receives reflected light with respect to the pulse light from the optical transmission path 2A that is disposed on the transmission side by using the optical reception unit 13. Consequently, the OTDR function measures, by using the reflected light received by the optical reception unit 13, the distance to the communication device that is disposed on the destination side and that is located on the bidirectional optical transmission path 2 and the distance to the fault location of the bidirectional optical transmission path 2.

In the following, an operation of the communication module 1C that performs the OTDR function will be described. If the control unit 20C detects activation of the OTDR function, the control unit 20C controls the first optical switch 17 in order to switch over to the path between the optical transmission unit 12 and the optical amplification unit 14. Furthermore, the control unit 20C controls the second optical switch 18 in order to switch over to the path between the optical amplification unit 14 and the transmission side isolator 15. Furthermore, the control unit 20C controls the third optical switch 19C in order to switch over to the path between the transmission side isolator 15 and the bidirectional optical transmission path 2. Consequently, a path along the path route of the optical transmission unit 12→the first optical switch 17→the optical amplification unit 14→the second optical switch 18→the transmission side isolator 15→the third optical switch 19C→the bidirectional optical transmission path 2 is formed.

The optical transmission unit 12 outputs the pulse light that is used for the OTDR function and that is to be optically amplified by the optical amplification unit 14 to the bidirectional optical transmission path 2 by way of the path route of the first optical switch 17→the optical amplification unit 14→the second optical switch 18→the transmission side isolator 15→the third optical switch 19C.

If the transmission of the pulse light from the third optical switch 19C to the bidirectional optical transmission path 2 has been completed, the control unit 20C controls the first optical switch 17 in order to switch over to the path between the reception side isolator 16 and the optical amplification unit 14. The control unit 20C controls the second optical switch 18 in order to switch over to the path between the optical amplification unit 14 and the third optical switch 19C. The control unit 20C controls the third optical switch 19C in order to switch over to the path between the bidirectional optical transmission path 2 and the second optical switch 18. Consequently, a path along the path route of the bidirectional optical transmission path 2→the third optical switch 19C→the second optical switch 18→the optical amplification unit 14→the first optical switch 17→the reception side isolator 16→the optical reception unit 13 is formed.

The optical reception unit 13 obtains the reflected light that is reflected with respect to the pulse light, that is used for the OTDR function, and that has been amplified by the optical amplification unit 14 by way of the path route of the bidirectional optical transmission path 2→the third optical switch 19C→the second optical switch 18→the optical amplification unit 14→the first optical switch 17→the reception side isolator 16. Then, the DSP 11 performs the OTDR function on the basis of the reflected light received by the optical reception unit 13.

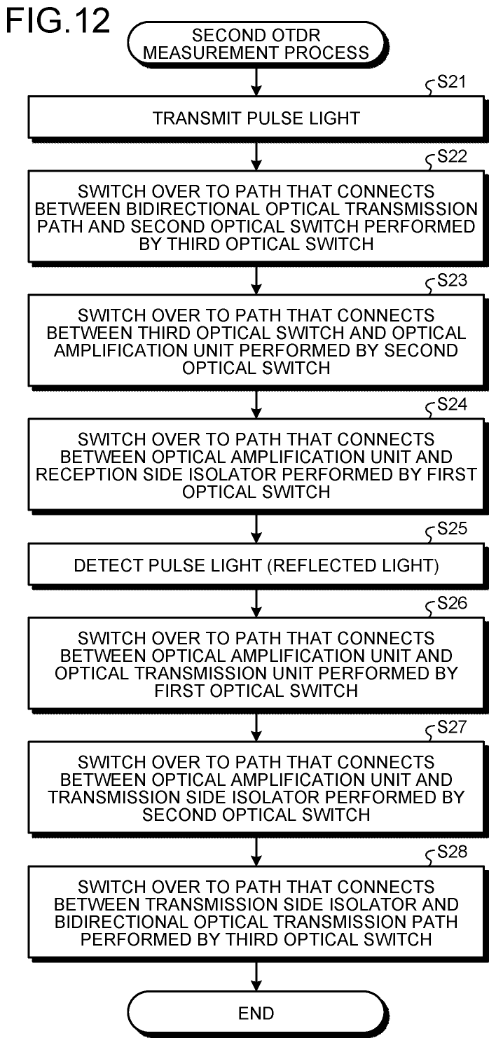

FIG. 12 is a flowchart illustrating one example of the processing operation related to the second OTDR measurement process performed by the control unit 20C. In FIG. 12, the control unit 20C forms a path along the path route of the optical transmission unit 12→the first optical switch 17→the optical amplification unit 14→the second optical switch 18→the transmission side isolator 15→the third optical switch 19C→the bidirectional optical transmission path 2. After having performed the path, the control unit 20C transmits the pulse light that is used for the OTDR from the optical transmission unit 12 (Step S21).

After having transmitted the pulse light, the control unit 20C controls the third optical switch 19C in order to switch over to the path between the bidirectional optical transmission path 2 and the second optical switch 18 (Step S22). The control unit 20C controls the second optical switch 18 in order to switch over to the path between the optical amplification unit 14 and the third optical switch 19C (Step S23). The control unit 20C controls the first optical switch 17 in order to switch over to the path between the reception side isolator 16 and the optical amplification unit 14 (Step S24).

If the control unit 20C detects reflected light by way of the optical reception unit 13 (Step S25), the control unit 20C controls the first optical switch 17 in order to switch over to the path between the optical transmission unit 12 and the optical amplification unit 14 (Step S26). Furthermore, the control unit 20C controls the second optical switch 18 in order to switch over to the path between the optical amplification unit 14 and the transmission side isolator 15 (Step S27). Furthermore, the control unit 20C controls the third optical switch 19C in order to switch over to the path between the transmission side isolator 15 and the bidirectional optical transmission path 2 (Step S28), and ends the processing operation illustrated in FIG. 12. Consequently, a path along the path route of the optical transmission unit 12→the first optical switch 17→the optical amplification unit 14→the second optical switch 18→the transmission side isolator 15→the third optical switch 19C→the bidirectional optical transmission path 2 is formed.

The communication module 1C according to the sixth embodiment switches optical amplification between the reception light and the transmission light by using the single unit of the optical amplification unit 14 that is disposed on the transmission path, so that there is no need to prepare a new optical amplification element, and it is thus possible to greatly contribute to a reduction in the size of the communication module 1C that includes the optical amplification unit as a built-in unit.

The communication module 1C controls the third optical switch 19C such that the path between the transmission side isolator 15 and the bidirectional optical transmission path 2 is switched to the path between the bidirectional optical transmission path 2 and the second optical switch 18. The communication module 1C controls the second optical switch 18 such that the path between the optical amplification unit 14 and the transmission side isolator 15 is switched to the path between the third optical switch 19C and the optical amplification unit 14. Furthermore, the communication module 1C controls the first optical switch 17 such that the path between the optical transmission unit 12 and the optical amplification unit 14 is switched to the path between the optical amplification unit 14 and the reception side isolator 16. Consequently, it is possible to implement optical amplification to be performed on the transmission light and the reception light in a switching manner by using the single unit of the optical amplification unit 14 that is disposed on the transmission path.

The communication module 1C detects reflected light with respect to the pulse light from the bidirectional optical transmission path 2 that has the OTDR function. When the communication module 1C detects the reflected light, the communication module 1C controls the third optical switch 19C such that the path between the transmission side isolator 15 and the bidirectional optical transmission path 2 is switched to the path between the bidirectional optical transmission path 2 and the second optical switch 18. The communication module 1 controls the second optical switch 18 such that the path between the optical amplification unit 14 and the transmission side isolator 15 is switched to the path between the third optical switch 19C and the optical amplification unit 14. The communication module 1 controls the first optical switch 17 such that the path between the optical transmission unit 12 and the optical amplification unit 14 is switched to the path between the optical amplification unit 14 and the reception side isolator 16. Consequently, it is possible to implement the OTDR function in long distance transmission by amplifying the reflected light using the single unit of the optical amplification unit 14 that is disposed on the transmission path.

If the transmission distance is a short distance, the communication module 1C controls the third optical switch 19C such that the path between the second optical switch 18 and the bidirectional optical transmission path 2 is connected. The communication module 1C controls the second optical switch 18 such that the path between the optical amplification unit 14 and the transmission side isolator 15 is switched to the path between the first optical switch 17 and the third optical switch 19C. The communication module 1C controls the first optical switch 17 such that the path between the optical transmission unit 12 and the optical amplification unit 14 is switched to the path between the second optical switch 18 and the reception side isolator 16. Consequently, it is possible to reduce the electrical power consumption caused by the optical amplification unit 14 in the case where the transmission distance of the bidirectional optical transmission path 2 is a short distance.

### (g) Seventh Embodiment

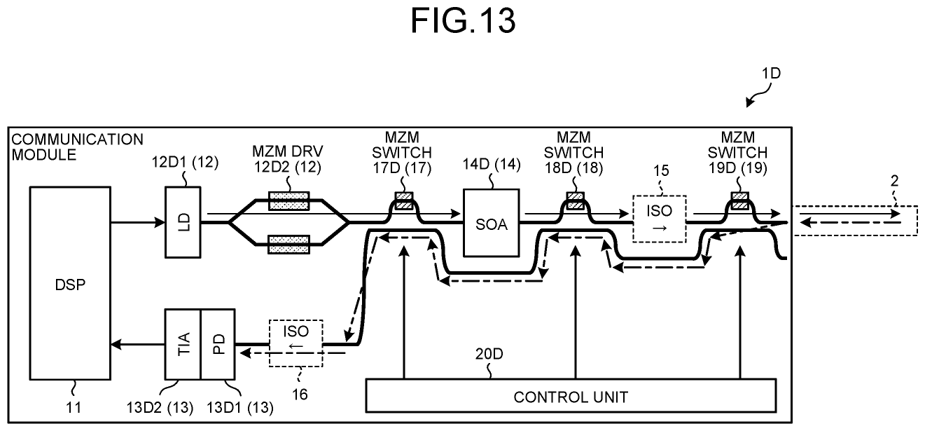

In the following, an embodiment indicating one example of the hardware of the communication module 1C according to the sixth embodiment will be described as a seventh embodiment. FIG. 13 is a diagram illustrating one example of a configuration of a communication module 1D according to the seventh embodiment. In addition, by assigning the same reference numerals to components having the same configuration as those in the communication module 1C according to the sixth embodiment, overlapped descriptions of the configuration and the operation thereof will be omitted.

The optical transmission unit 12 included in the communication module 1D includes a laser diode (LD) 12D1 and a Mach-Zehnder Modulator (MZM) 12D2. The optical reception unit 13 includes a Photo Diode (PD) 13D1 and a Transimpedance Amplifier (TIA) 13D2. The optical amplification unit 14 is constituted by, for example, a semiconductor optical amplifier (SOA) 14D.

The transmission side isolator 15 is an isolator (ISO). The reception side isolator 16 is an isolator (ISO). The first optical switch 17 is constituted by, for example, a MZM switch 17D. The second optical switch 18 is constituted by, for example, a MZM switch 18D. The third optical switch 19C is constituted by, for example, a MZM switch 19D. The MZM 12D2, the MZM switch 17D, the MZM switch 18D, and the MZM switch 19D are formed by using the silicon photonics technology. A control unit 20D included in the communication module 1D performs switching control on the MZM switch 17D, the MZM switch 18D, and the MZM switch 19D.

The communication module 1D according to the seventh embodiment switches optical amplification between the reception light and the transmission light by using the single unit of the SOA 14D, so that there is no need to prepare a new SOA, and it is thus possible to greatly contribute to a reduction in the size of the communication module 1D having the SOA 14D as a built-in unit. In addition, the MZM 12D2, the MZM switch 17D, the MZM switch 18D, and the MZM switch 19D are formed by using the silicon photonics technology, so that it is possible to greatly contribute to a reduction in the size of the communication module 1D.

Each of the components in the units illustrated in the drawings is not always physically configured as illustrated in the drawings. In other words, the specific shape of a separate or integrated unit is not limited to the drawings; however, all or part of the unit can be configured by functionally or physically separating or integrating any of the units depending on various kinds of loads or use conditions.

According to one aspect of an embodiment, it is possible to contribute to a reduction in size of a communication module by sharing a single unit of optical amplification unit.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical amplifier comprising:
a first path through which first signal light passes;
a second path through which second signal light passes;
an optical amplification unit that is arranged on one of the first path and the second path and that optically amplifies the first signal light or the second signal light;
a first optical switch that is arranged on an input stage of the optical amplification unit and that switches a path that connects between the first path and the optical amplification unit or a path that connects between the second path and the optical amplification unit; and
a second optical switch that is arranged on an output stage of the optical amplification unit and that switches a path that connects between the first path and the optical amplification unit or a path that connects between the second path and the optical amplification unit, wherein
the path that connects between the first path and the optical amplification unit is switched to the path that connects between the second path and the optical amplification unit by the first optical switch and the path that connects between the first path and the optical amplification unit is switched to the path that connects between the second path and the optical amplification unit by the second optical switch.

2. The optical amplifier according to claim 1, wherein
the first path includes
a first input unit that inputs the first signal light, and
a first output unit that outputs the first signal light,
the second path includes
a second input unit that inputs the second signal light that is different from the first signal light, and
a second output unit that outputs the second signal light,
the first optical switch connects a path between the first input unit and the optical amplification unit,
the second optical switch connects a path between the optical amplification unit and the first output unit, and connects a path between the first optical switch and the second input unit,
the path between the optical amplification unit and the first output unit is switched to a path between the second input unit and the optical amplification unit by the second optical switch, and
the path between the first input unit and the optical amplification unit is switched to a path between the optical amplification unit and the second output unit by the first optical switch.

3. The optical amplifier according to claim 2, further including:
an isolator that allows an input of the first signal light to pass through one of a portion between the second optical switch and the first output unit and a portion between the second optical switch and the second input unit; and
a third optical switch that connects a path between the isolator and the first output unit, and that connects a path between the second input unit and the second optical switch, wherein
the path between the isolator and the first output unit is switched to a path between the first output unit and the second optical switch by the third optical switch,
the path between the optical amplification unit and the first output unit is switched to a path between the third optical switch and the optical amplification unit by the second optical switch, and
the path between the first input unit and the optical amplification unit is switched to a path between the second output unit and the optical amplification unit by the first optical switch.

4. A communication module comprising:
an optical transmitter that transmits one of pieces of signal light between first signal light and second signal light;
an optical receiver that receives the other of the pieces of signal light between the first signal light and the second signal light; and
an optical amplifier that is arranged between the optical transmitter and the optical receiver, wherein
the optical amplifier includes
a first path through which the first signal light passes,
a second path through which the second signal light passes,
an optical amplification unit that is arranged on one of the first path and the second path, and that optically amplifies the first signal light or the second signal light,
a first optical switch that is arranged on an input stage of the optical amplification unit, and that switches a path that connects between the first path and the optical amplification unit or a path that connects between the second path and the optical amplification unit, and
a second optical switch that is arranged on an output stage of the optical amplification unit, and that switches a path that connects between the first path and the optical amplification unit or a path that connects between the second path and the optical amplification unit, and
the path that connects between the first path and the optical amplification unit is switched to the path that connects between the second path and the optical amplification unit by the first optical switch and the path that connects between the first path and the optical amplification unit is switched to the path that connects between the second path and the optical amplification unit by the second optical switch.

5. The communication module according to claim 4, wherein
the first path includes
a first input unit that is connected to the optical transmission unit and that inputs the first signal light, and
a first output unit that outputs the first signal light,
the second path includes
a second input unit that inputs the second signal light, and
a second output unit that is connected to the optical receiver and that outputs the second signal light,
the first optical switch connects a path between the first input unit and the optical amplification unit,
the second optical switch connects a path between the optical amplification unit and the first output unit, and connects a path between the first optical switch and the second input unit,
the path between the optical amplification unit and the first output unit is switched to a path between the second input unit and the optical amplification unit by the second optical switch, and
the path between the first input unit and the optical amplification unit is switched to a path between the optical amplification unit and the second output unit by the first optical switch.

6. The communication module according to claim 5, wherein
the optical amplification unit includes
an isolator that allows the first signal light to pass through one of a portion between the second optical switch and the first output unit and a portion between the second optical switch and the second input unit, and
a third optical switch that connects a path between the isolator and the first output unit, and that connects a path between the second input unit and the second optical switch,
the path between the isolator and the first output unit is switched to a path between the first output unit and the second optical switch by the third optical switch,
a path between the optical amplification unit and the isolator is switched to a path between the third optical switch and the optical amplification unit by the second optical switch, and
the path between the first input unit and the optical amplification unit is switched to the path between the optical amplification unit and the second output unit by the first optical switch.

7. The communication module according to claim 6, wherein
a path between the second optical switch and the first output unit is connected by the third optical switch,
the path between the optical amplification unit and the isolator is switched to a path between the first optical switch and the third optical switch by the second optical switch, and
the path between the first input unit and the optical amplification unit is switched to a path between the second optical switch and the second output unit by the first optical switch.

8. The communication module according to claim 6, wherein
the first output unit is connected to a first optical transmission path,
the second input unit is connected to a second optical transmission path that is different from the first optical transmission path,
the third optical switch connects a path between the isolator and the first optical transmission path, and connects a path between the second optical transmission path and the second optical switch,
the path between the isolator and the first output unit is switched to the path between the first output unit and the second optical switch by the third optical switch,
the path between the optical amplification unit and the isolator is switched to the path between the third optical switch and the optical amplification unit by the second optical switch, and
the path between the first input unit and the optical amplification unit is switched to the path between the optical amplification unit and the second output unit by the first optical switch.

9. The communication module according to claim 6, wherein
the first output unit and the second input unit are connected to an optical transmission path,
the third optical switch connects a path between the isolator and the optical transmission path, and connects a path between the optical transmission path and the second optical switch,
the path between the isolator and the first output unit is switched to the path between the first output unit and the second optical switch by the third optical switch,
the path between the optical amplification unit and the isolator is switched to the path between the third optical switch and the optical amplification unit by the second optical switch, and
the path between the first input unit and the optical amplification unit is switched to the path between the optical amplification unit and the second output unit by the first optical switch.

10. An optical transmission apparatus comprising:
an optical transmitter that transmits one of pieces of signal light between first signal light and second signal light according to transmission data;
an optical receiver that receives the other of the pieces of signal light between the first signal light and the second signal light according to reception data;
an optical amplifier that is arranged between the optical transmitter and the optical receiver; and
a signal processor that sets the transmission data with respect to the optical transmitter and that acquires the reception data from the optical receiver, wherein
the optical amplifier includes
a first path through which the first signal light passes,
a second path through which the second signal light passes,
an optical amplification unit that is arranged on one of the first path and the second path, and that optically amplifies the first signal light or the second signal light,
a first optical switch that is arranged on an input stage of the optical amplification unit, and that switches a path that connects between the first path and the optical amplification unit or a path that connects between the second path and the optical amplification unit, and
a second optical switch that is arranged on an output stage of the optical amplification unit, and that switches a path that connects between the first path and the optical amplification unit or a path that connects between the second path and the optical amplification unit, and
the path that connects between the first path and the optical amplification unit is switched to the path that connects between the second path and the optical amplification unit by the first optical switch and the path that connects between the first path and the optical amplification unit is switched to the path that connects between the second path and the optical amplification unit by the second optical switch.
